(19) United States
(12) Patent Application Publication
(10) Pub. No.: US 2012/0235891 A1
(43) Pub. Date: Sep. 20, 2012

(54) LIQUID CRYSTAL DISPLAY DEVICE

(76) Inventors: Rena Nishitani, Tokyo (JP); Tomohiro Sasagawa, Tokyo (JP); Eiji Niikura, Tokyo (JP); Muneharu Kuwata, Tokyo (JP); Kuniko Kojima, Tokyo (JP)

(21) Appl. No.: 13/513,203

(22) PCT Filed: Nov. 29, 2010
(86) PCT No.: PCT/JP2010/006937

§ 371 Date: Jun. 1, 2012

(30) Foreign Application Priority Data
Dec. 2, 2009 (JP) 2009-274546
Feb. 5, 2010 (JP) 2010-024761

(51) Int. Cl. G09G 3/36

(52) U.S. Cl. 345/102

(57) ABSTRACT

A liquid crystal display device has a first backlight unit and a second backlight unit. The first backlight unit includes a first optical member that transmits light incident from the second backlight unit, converts light output from a light source to light having a narrow-angle directional distribution, and radiates the converted light toward the rear surface of the liquid crystal display panel. The second backlight unit includes a second optical member that converts light output from a light source to light having a wide-angle directional distribution, and radiates the converted light toward the rear surface of the liquid crystal display panel.

### TECHNICAL FIELD

The present invention relates to a liquid crystal display device, more particularly to a liquid crystal display device having a viewing angle control function.

### BACKGROUND ART

A transmissive or semi-transmissive liquid crystal display device is generally provided with a liquid crystal display panel having a liquid crystal layer and a light source unit (backlight) that directs light toward the rear surface of the liquid crystal display panel. In recent years, liquid crystal display devices have been proposed that have a viewing angle control function that changes the viewing angle according to the displayed content or display conditions by controlling the directional distribution of the light output by the backlight.

For example, a liquid crystal display device having a viewing angle control mechanism disposed between the backlight and the liquid crystal display panel is disclosed in Japanese Patent No. 4164077 (patent document 1). The viewing angle control mechanism of this liquid crystal display device assumes one of two states depending on a voltage supplied from a power supply unit: a transparent state that transmits substantially all of the light emitted by the backlight, and a nontransparent scattering state (clouded state) that scatters the light emitted by the backlight. When the voltage is supplied from the power supply unit, the viewing angle control mechanism assumes the transparent state, which provides a narrow viewing angle; when the voltage is not supplied from the power supply unit, the viewing angle control mechanism assumes the nontransparent scattering state, which provides a wide viewing angle.

### PRIOR ART REFERENCES

### Patent Documents

Patent document 1: Japanese patent No. 4164077

### SUMMARY OF THE INVENTION

### Problems to be Solved by the Invention

To switch from one state to the other in response to a supplied voltage, however, the viewing angle control mechanism described in patent document 1 requires a complex active optical element. This type of active optical element also has low transmittance, which leads to reduced optical efficiency. If this type of active optical element is used, accordingly, there are problems of complex structure of the liquid crystal display device, high power consumption, and high manufacturing cost.

In view of the above, an object of the present invention is to provide a liquid crystal display device that can implement viewing angle control with low power consumption and a simple structure.

### Means for Solving the Problem

A liquid crystal display device according to a first aspect of the invention includes: a liquid crystal display panel having a rear surface and a display surface on a side opposite the rear surface, for modulating light entering from the rear surface to generate image light and outputting the image light from the display surface; a first backlight unit for illuminating the rear surface of the liquid crystal display panel with light; a second backlight unit for radiating light toward a rear surface of the first backlight unit; a first light source driving and control unit for controlling the amount of light emitted by the first backlight unit; and a second light source driving and control unit for controlling the amount of light emitted by the second backlight unit. The first backlight unit includes: a first light source controlled by the first light source driving and control unit; a first optical member for transmitting the light radiated by the second backlight unit, and for converting light output by the first light source to light having a narrow-angle directional distribution in which light having a predetermined or greater intensity is localized to a first angular range centered on a direction normal to the display surface of the liquid crystal display panel and radiating the converted light toward the liquid crystal display panel; and a first optical sheet for transmitting the light radiated by the second backlight unit and for reflecting, toward the first optical member, by total internal reflection, light radiated from a side of the first optical member facing oppositely away from the liquid crystal display panel. The second backlight unit includes: a second light source controlled by the second light source driving and control unit; and a second optical member for converting light output from the second light source to light having a wide-angle directional distribution in which light having a predetermined or greater intensity is localized to a second angular range wider than the first angular range, and radiating the converted light toward the rear surface of the first backlight unit. The first optical member and the first optical sheet transmit the light radiated from the second optical member without narrowing the wide-angle directional distribution.

A liquid crystal display device according to a second aspect of the invention includes: a liquid crystal display panel having a rear surface and a display surface on a side opposite the rear surface, for modulating light entering from the rear surface to generate image light and outputting the image light from the display surface; a first backlight unit for illuminating the rear surface of the liquid crystal display panel with light; a second backlight unit for radiating light toward a rear surface of the first backlight unit; a first light source driving and control unit for controlling the amount of light emitted by the first backlight unit; and a second light source driving and control unit for controlling the amount of light emitted by the second backlight unit. The first backlight unit includes: a first light source controlled by the first light source driving and control unit; and a first optical member for transmitting the light radiated by the second backlight unit, and for converting light output by the first light source to light having a first directional distribution in which light having a predetermined or greater intensity is localized to a first angular range centered on a direction normal to the display surface of the liquid crystal display panel and radiating the converted light toward the liquid crystal display panel. The second backlight unit includes: a second light source controlled by the second light source driving and control unit; and a second optical member for converting light output from the second light source to light having a second directional distribution in which light having a predetermined or greater intensity is localized to a second angular range centered on the direction normal to the display surface of the liquid crystal display panel, and radiating the converted light toward the rear surface of the first backlight unit. The first optical member converts the light radiated from the second optical member to light having a third directional distribution in which light having a predetermined or greater intensity is localized to a third angular range centered on a direction inclined at a predetermined angle from the direction normal to the display surface of the liquid crystal display panel, and radiates the converted light toward the liquid crystal display panel.

### Effect of the Invention

With the present invention, a low-power liquid crystal display device can be provided that can perform viewing angle control without using a complex active optical element.

### BRIEF DESCRIPTION OF THE DRAWINGS

FIG. 1 schematically illustrates the structure of a liquid crystal display device (a transmissive liquid crystal display device) in a first embodiment of the invention.

FIG. 2 schematically illustrates part of the structure of the liquid crystal display device in FIG. 1 seen from the Y axis direction.

FIGS. 3(a) and 3(b) show a diagrammatic example of the optical structure of the light guide plate in the first backlight unit in the first embodiment.

FIG. 4 is a graph showing results calculated by simulation of the directional distribution of the light radiated from the light guide plate shown in FIGS. 3(a) and 3(b).

FIGS. 5(a) and 5(b) show a diagrammatic example of the optical structure of the downward prism sheet in the first backlight unit in the first embodiment.

FIG. 6 is a graph showing results calculated by simulation of the directional distribution of the illumination light radiated from the downward prism sheet.

FIGS. 7(a) and 7(b) diagrammatically illustrate the optical effect of the optical microelements formed on the rear surface of the downward prism sheet.

FIGS. 8(a) and 8(b) show a diagrammatic example of the optical structure of the upward prism sheet in the first backlight unit in the first embodiment.

FIGS. 9(a) and 9(b) diagrammatically illustrate the optical effect of the optical microelements formed on the front surface of the upward prism sheet.

FIGS. 10(a) and 10(b) diagrammatically illustrate the optical effect of the optical microelements on the upward prism sheet when the array direction of the optical microelements on the upward prism sheet is aligned with the array direction of the optical microelements on the downward prism sheet.

FIG. 11 is a graph showing measured results of the directional distribution of the illumination light radiated from the backlight unit.

FIG. 12 is a graph showing other measured results of the directional distribution of the illumination light radiated from the backlight unit.

FIGS. 13(a), 13(b), and 13(c) show three diagrammatic examples of the directional distribution of the illumination light.

FIGS. 14(a), 14(b), and 14(c) schematically show three examples of viewing angle control.

FIG. 15 schematically illustrates the structure of a liquid crystal display device (a transmissive liquid crystal display device) in a second embodiment of the invention.

FIG. 16 schematically illustrates part of the structure of the liquid crystal display device in FIG. 15 seen from the Y axis direction.

FIG. 17 schematically illustrates the structure of a liquid crystal display device (a transmissive liquid crystal display device) in a third embodiment of the invention.

FIG. 18 schematically illustrates part of the structure of the liquid crystal display device in FIG. 17 seen from the Y axis direction.

FIG. 19 is a graph showing results calculated by simulation of the directional distribution of the illumination light radiated from the second backlight unit in the third embodiment.

FIG. 20 is a graph showing results calculated by simulation of the directional distribution of the illumination light radiated from the second backlight unit in the third embodiment after transmission through the downward prism sheet.

FIGS. 21(a), 21(b), and 21(c) show three diagrammatic examples of the directional distribution of the illumination light.

FIGS. 22(a), 22(b), and 22(c) schematically show three examples of viewing angle control.

FIG. 23 schematically illustrates the structure of a liquid crystal display device (a transmissive liquid crystal display device) in a variation of the third embodiment of the invention.

FIG. 24 schematically illustrates part of the structure of the liquid crystal display device in FIG. 23 seen from the Y axis direction.

### MODES FOR CARRYING OUT THE INVENTION

Embodiments of the invention will be described below with reference to the drawings.

### First Embodiment

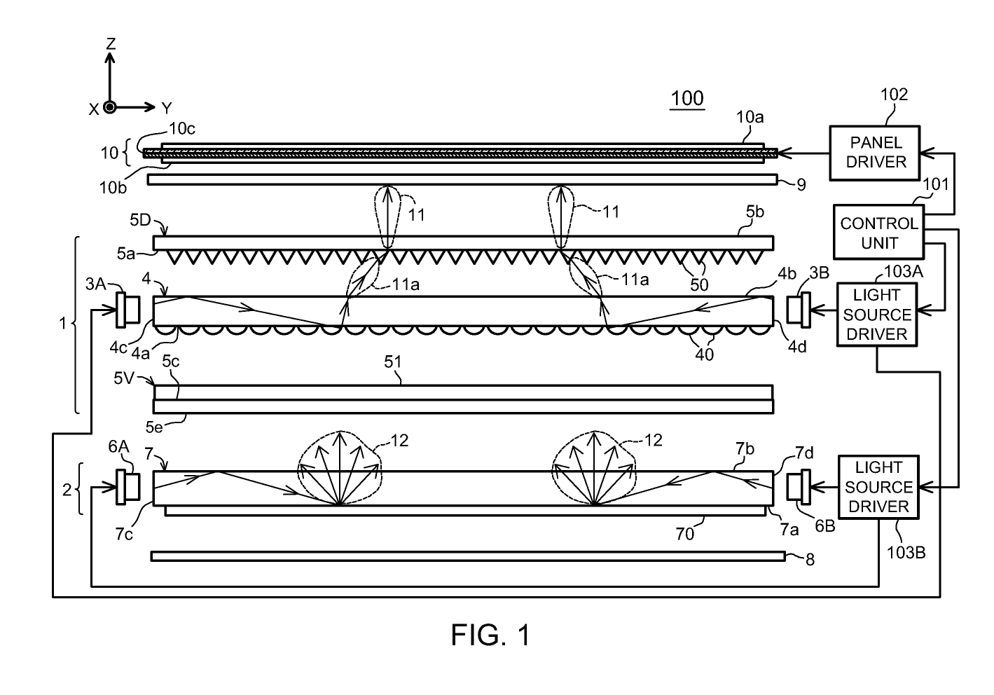

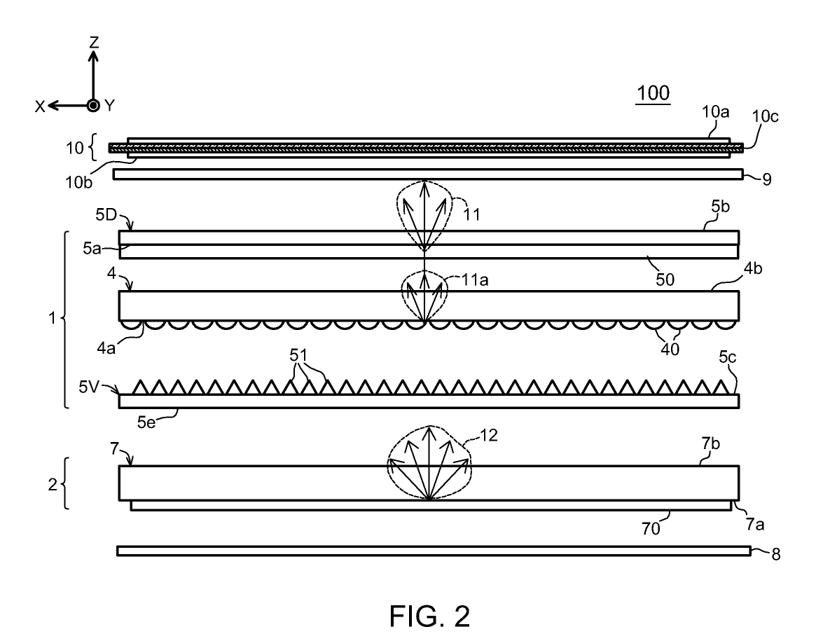

FIG. 1 schematically illustrates the structure of a liquid crystal display device (a transmissive liquid crystal display device) 100 in the first embodiment of the invention. FIG. 2 schematically illustrates part of the structure of the liquid crystal display device 100 in FIG. 1 seen from the Y axis direction. As shown in FIG. 1, the liquid crystal display device 100 includes, in order on a Z axis, a liquid crystal display panel 10, an optical sheet 9, a first backlight unit 1, a second backlight unit 2, and a light reflecting sheet 8. The liquid crystal display panel 10 has a display surface 10a parallel to an X-Y plane including X and Y axes, which are orthogonal to the Z axis. The X and Y axes are mutually orthogonal.

The liquid crystal display device 100 also has a panel driver 102 that drives the liquid crystal display panel 10, a light source driver 103A that drives light sources 3A, 3B included in the first backlight unit 1, and a light source driver 103B that drives light sources 6A, 6B included in the second backlight unit 2. The operation of the panel driver 102 and the light source drivers 103A, 103B is controlled by a control unit 101.

The control unit 101 carries out image processing on a video signal supplied from a signal source (not shown) to generate control signals, and supplies these control signals to the panel driver 102 and light source drivers 103A, 103B. The light source drivers 103A, 103B drive the light sources 3A, 3B, 6A, 6B in response to the control signals from the control unit 101, causing the light sources 3A, 3B, 6A, 6B to emit light.

The first backlight unit 1 converts the light emitted by light sources 3A and 3B to illumination light 11 with a narrow-angle directional distribution (a directional distribution in which light having a predetermined or greater intensity is localized to a comparatively narrow angular range centered on the direction normal to the display surface 10a of the liquid crystal display panel 10, that is, the Z axis direction) and directs this light toward the rear surface 10b of the liquid crystal display panel 10. This illumination light 11 illuminates the rear surface 10b of the liquid crystal display panel 10 through the optical sheet 9. The optical sheet 9 suppresses minor illumination irregularities and other optical effects. The second backlight unit 2 converts the light emitted by light sources 6A and 6B to illumination light 12 with a wide-angle directional distribution (a directional distribution in which light having a predetermined or greater intensity is localized to a comparatively wide angular range centered on the Z axis direction) and directs this light toward the rear surface 10b of the liquid crystal display panel 10. This illumination light 12 passes through the first backlight unit 1 and illuminates the rear surface 10b of the liquid crystal display panel 10 through the optical sheet 9.

The light reflecting sheet 8 is disposed directly below the second backlight unit 2. The part of the light emitted toward the rear from the first backlight unit 1 that passes through the second backlight unit 2 and the light emitted toward the rear from the second backlight unit 2 are reflected by the light reflecting sheet 8 and used as illumination light to illuminate the rear surface 10b of the liquid crystal display panel 10. A light reflecting sheet having a plastic base material such as polyethylene terephthalate or a light reflecting sheet having a layer of gold evaporated onto the surface of a base plate, for example, may be used as the light reflecting sheet 8.

The liquid crystal display panel 10 has a liquid crystal layer 10c extending in the X-Y plane, which is orthogonal to the Z axis. The display surface 10a of the liquid crystal display panel 10 has a rectangular shape; the X and Y axis directions indicated in FIG. 1 parallel two mutually orthogonal sides of the display surface 10a. The panel driver 102 varies the transmittance of the liquid crystal layer 10c pixel by pixel in response to control signals supplied from the control unit 101. The liquid crystal display panel 10 thereby spatially modulates the illumination light incident from one or both of the first and second backlight units 1, 2 to generate image light, which can then exit through the display surface 10a. When only light sources 3A and 3B are driven and light sources 6A and 6B are not driven, illumination light 11 with a narrow-angle directional distribution is radiated from the first backlight unit 1, so the viewing angle of the liquid crystal display device 100 is narrow; when only light sources 6A and 6B are driven, illumination light 12 with a wide-angle directional distribution is radiated from the second backlight unit 2, so the viewing angle of the liquid crystal display device 100 is wide. The control unit 101 can also control the light source drivers 103A, 103B individually to adjust the intensity ratio of the illumination light 11 emitted from the first backlight unit 1 and the illumination light 12 emitted from the second backlight unit 2.

As shown in FIG. 1, the first backlight unit 1 includes light sources 3A, 3B, a light guide plate 4 disposed parallel to the display surface 10a of the liquid crystal display panel 10, an optical sheet 5D (referred to below as the downward prism sheet 5D), and an optical sheet 5V (referred to below as the upward prism sheet 5V). The light emitted from light sources 3A, 3B is converted to illumination light 11 having a narrow-angle directional distribution by the combination of the light guide plate 4 and the downward prism sheet 5D (this combination is the first optical member). The light guide plate 4 is a plate-shaped member formed from a transparent optical material such as an acrylic plastic (PMMA); its rear surface 4a (the surface on the side facing away from the liquid crystal display panel 10) has a structure in which a regular array of optical microelements 40 projecting away from the liquid crystal display panel 10 is disposed in a plane parallel to the display surface 10a. The shape of the optical microelements 40 forms part of a spherical shape, and their surfaces have a fixed radius of curvature.

The upward prism sheet 5V has an optical structure that transmits the illumination light 12 having a wide-angle directional distribution output by the second backlight unit 2, and also has an optical structure that reflects light radiated from the rear surface 4a of the light guide plate 4 back in the direction of the light guide plate 4. The light radiated from the rear surface 4a of the light guide plate 4 is reflected by the upward prism sheet 5V, changing its direction of propagation to a direction toward the liquid crystal display panel 10, and after passage through the light guide plate 4 and the downward prism sheet 5D, it can be used as illumination light having a narrow-angle directional distribution.

Light sources 3A and 3B, which include, for example, a plurality of laser emitters arrayed in the X axis direction, are disposed facing the edges (entrance surfaces) 4c, 4d of the light guide plate 4 in the Y axis direction. The light emitted from these light sources 3A, 3B enters the light guide plate 4 through its entrance surfaces 4c, 4d, respectively, and propagates by total internal reflection within the light guide plate 4. Part of this light is reflected by the optical microelements 40 on the rear surface 4a of the light guide plate 4 and is radiated through the front surface (exit surface) 4b of the light guide plate 4 as illumination light 11a. The optical microelements 40 convert the light propagating through the interior of the light guide plate 4 to light having a directional distribution centered on a direction inclined at a predetermined angle from the Z axis direction, and direct this light outward through the front surface 4b. This light 11a radiated from the light guide plate 4 enters optical microelements 50 on the downward prism sheet 5D; after total internal reflection by the sloping surfaces of the optical microelements 50, the light exits through the front surface (exit surface) 5b as illumination light 11.

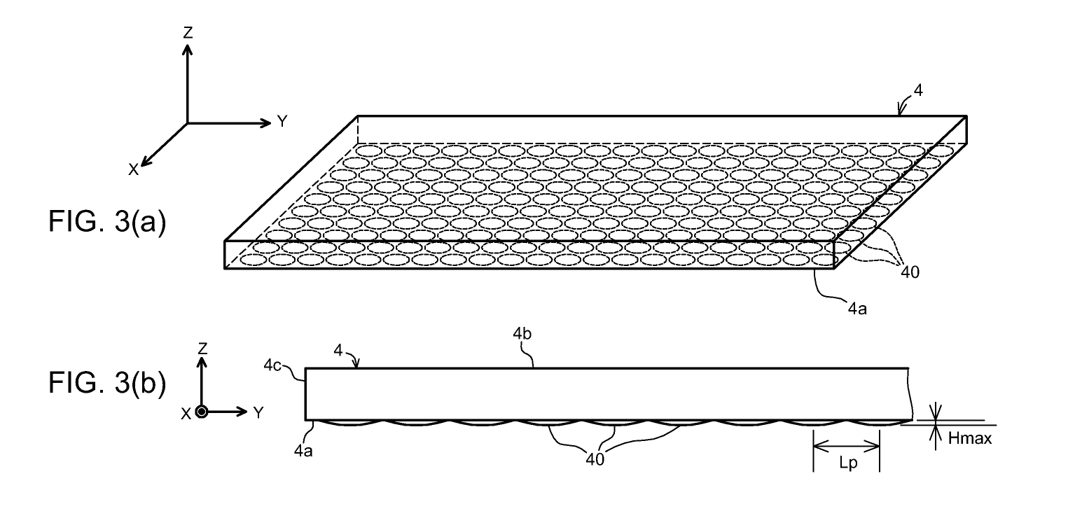

FIGS. 3(a) and 3(b) show a diagrammatic example of the optical structure of the light guide plate 4. FIG. 3(a) shows a diagrammatic perspective view of an exemplary optical structure of the rear surface 4a of the light guide plate 4; FIG. 3(b) shows part of the structure of the light guide plate 4 shown in FIG. 3(a), seen from the X axis direction. As shown in FIG. 3(a), the projecting convex spherically shaped optical microelements 40 are arrayed two-dimensionally on the rear surface 4a of the light guide plate 4 (in the X-Y plane).

As an example of the optical microelements 40, optical microelements having a refractive index of approximately 1.49, a maximum height Hmax of approximately 0.005 mm, and a surface with a radius of curvature of approximately 0.15 mm, for example, may be used. The center-to-center spacing Lp of the optical microelements 40 may be 0.77 mm. Although the light guide plate 4 may be made from an acrylic plastic, it is not limited to that material. Other plastic materials having good optical transparency and excellent processability, such as polycarbonate plastics, may be used instead of an acrylic plastic, or a glass material may be used.

As noted above, the light exiting light sources 3A, 3B enters the interior of the light guide plate 4 through its side edges 4c, 4d. As this incident light propagates within the light guide plate 4, it is totally reflected by the refractive index difference between the optical microelements 40 of the light guide plate 4 and an air layer, and is radiated from the front surface 4b of the light guide plate 4 toward the liquid crystal display panel 10. The optical microelements 40 shown in FIGS. 3(a) and 3(b) are arranged in a substantially regular array, but to obtain a uniform surface brightness distribution of the radiated light 11a radiating from the front surface 4b of the light guide plate 4, the density of optical microelements 40, i.e., the number per unit area, may increase with increasing distance from the edges 4c, 4d, and the density may decrease with increasing proximity to the edges 4c, 4d. Alternatively, the optical microelements 40 may be formed so as to increase in density with increasing proximity to the center of the light guide plate 4, and become more sparse in steps with increasing distance from the center.

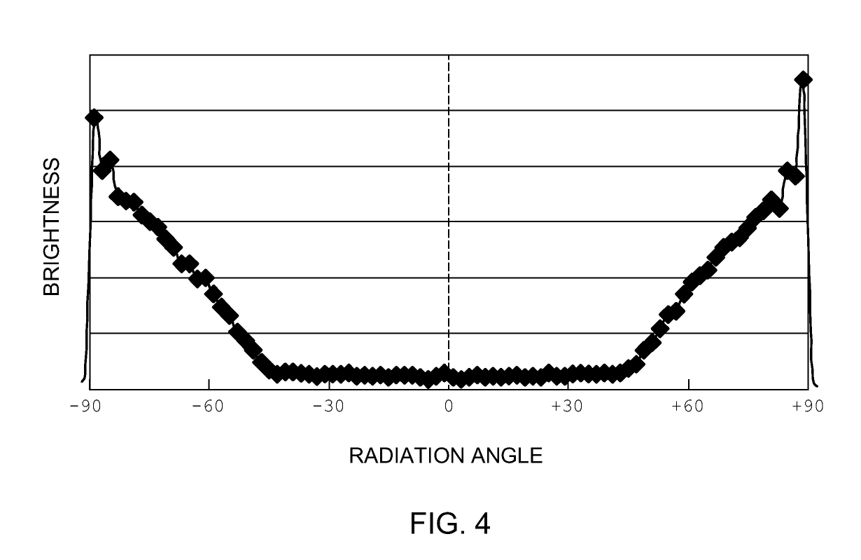

FIG. 4 is a graph showing results calculated by simulation of the directional distribution (angular brightness distribution) of the radiated light 11a radiated from the front surface 4b of the light guide plate 4. The horizontal axis of the graph in FIG. 4 represents the angle of radiation of the radiated light 11a, and the vertical axis represents brightness. As shown in FIG. 4, the radiated light 11a has a directional distribution with a width (full width at half maximum: FWHM) of approximately 30 degrees centered on axes inclined at angles of approximately ±75 degrees to the Z axis direction. That is, the radiated light 11a has a directional distribution such that light with an intensity equal to or greater than the full width half maximum value is localized in an angular range of approximately +60 degrees to +90 degrees centered on an axis inclined at an angle of approximately +75 degrees to the Z axis direction, and an angular range of approximately −60 degrees to −90 degrees centered on an axis inclined at an angle of approximately −75 degrees to the Z axis direction. The light emitted from light source 3B, which is to the right in FIG. 1, is internally reflected by the optical microelements 40 and becomes light radiated in the angular range from −60 degrees to −90 degrees; the light emitted from light source 3A, which is to the left in FIG. 1, is internally reflected by the optical microelements 40 and becomes light radiated in the angular range of +60 degrees to +90 degrees. This type of directional distribution can also be generated if the optical microelements 40 are formed with prismatic shapes instead of convex spherical shapes.

As described below, by generating radiated light 11a localized in these two angular ranges, it is possible to have the radiated light 11a internally incident on the optical microelements 50 of the downward prism sheet 5D totally reflected by the inner surfaces of the optical microelements 50. The light generated by total internal reflection in the optical microelements 50 becomes illumination light 11 having a narrow-angle directional distribution localized in a narrow angular range centered on the Z axis direction.

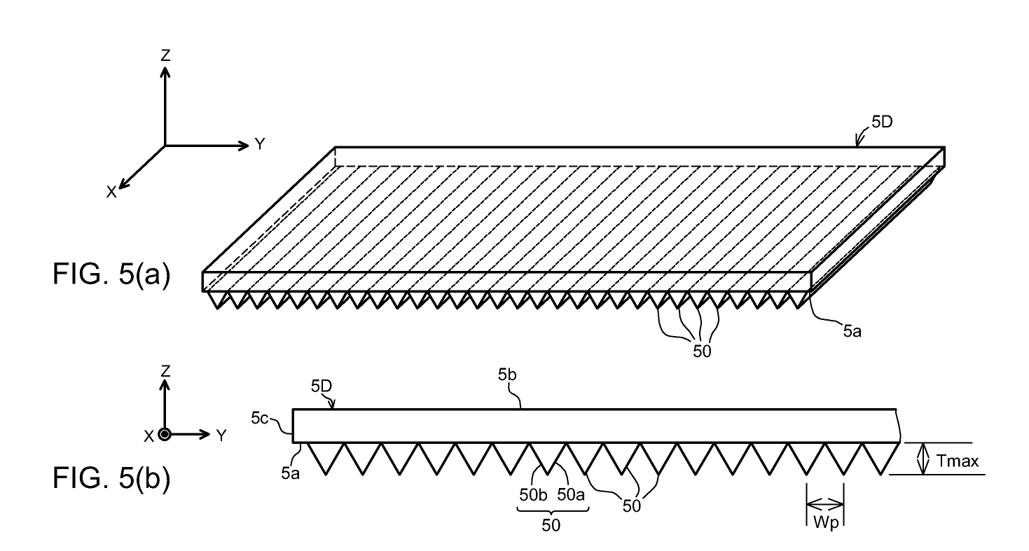

Next, the optical structure of the downward prism sheet 5D will be described. FIGS. 5(a) and 5(b) show a diagrammatic example of the optical structure of the downward prism sheet in the first backlight unit in the first embodiment. FIG. 5(a) shows a rough perspective view of an exemplary optical structure of the rear surface 5a of the downward prism sheet 5D. FIG. 5(b) shows part of the structure of the downward prism sheet 5D shown in FIG. 5(a), seen from the X axis direction. As shown in FIG. 5(a), the rear surface 5a of the downward prism sheet 5D (the surface facing the light guide plate 4) has a structure in which a regular array of optical microelements 50 extends in the Y axis direction in a plane parallel to the display surface 10a. Each optical microelement 50 forms a projecting part having the shape of a triangular prism, the vertex part of the optical microelement 50 projecting oppositely away from the liquid crystal display panel 10, the vertex line in the vertex part extending in the X axis direction. The optical microelements 50 are regularly spaced. Each optical microelement 50 has two sloping surfaces 50a, 50b inclined from the Z axis direction in the positive Y axis direction and the negative Y axis direction, respectively.

The radiated light 11a radiated from the front surface 4b of the light guide plate 4 is incident on the rear surface 5a of the downward prism sheet 5D, thus on the optical microelements 50. This incident light undergoes total internal reflection on one of the sloping surfaces 50a, 50b that form the triangular prism of each optical microelement 50 and is thereby deflected closer to the normal direction of the liquid crystal display panel 10 (the Z axis direction), becoming illumination light 11 having a directional distribution with a narrow width and high central brightness.

As an example of the optical microelements 50, optical microelements having a refractive index of approximately 1.49 and a maximum height Tmax of approximately 0.022 mm, for example, may be used and the vertex angle formed by the sloping surfaces 50a, 50b (the vertex angle of the isosceles triangular shapes in the cross section in FIG. 5(b)) may be 68 degrees. The center-to-center spacing Wp of the optical microelements 50 in the Y axis direction may be 0.03 mm. Although the downward prism sheet 5D may be made from PMMA, it is not limited to that material. Other plastic materials having good optical transparency and excellent processability, such as polycarbonate plastic materials, may be used, or glass materials may be used.

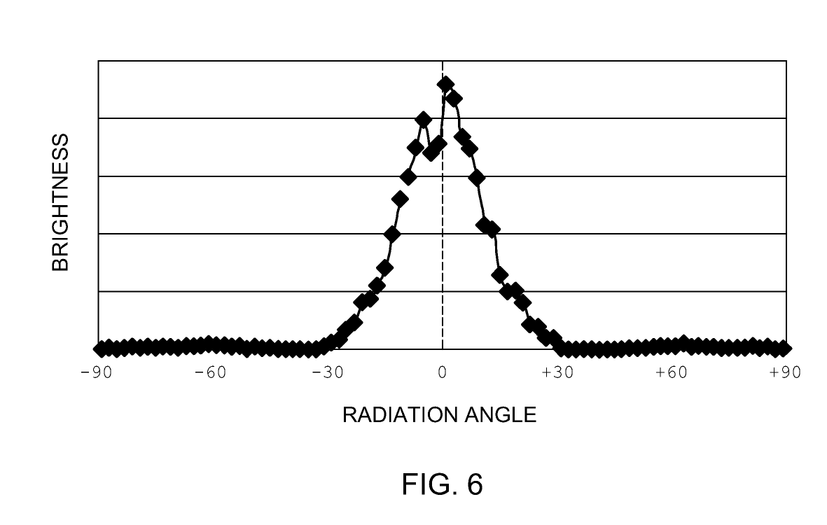

FIG. 6 is a graph showing results calculated by simulation of the directional distribution of the illumination light 11 radiated from the front surface 5b of the downward prism sheet 5D. The horizontal axis of the graph in FIG. 6 represents the angle of radiation of the illumination light 11, and the vertical axis represents brightness. The directional distribution in FIG. 6 does not include light radiated from the second backlight unit 2 that passes through the first backlight unit 1. As shown in FIG. 6, the illumination light 11 has a directional distribution with a width (full width at half maximum: FWHM) of approximately 30 degrees centered on the Z axis direction. That is, the directional distribution of the illumination light 11 has a narrow-angle directional distribution in which light with an intensity equal to or greater than the full width half maximum value is localized in an angular range of approximately −15 degrees to +15 degrees centered on the Z axis direction

The narrow-angle directional distribution shown in FIG. 6 assumes that the light 11a radiated from the light guide plate 4 has the directional distribution shown in FIG. 4.

The directional distribution in FIG. 4 was obtained as a result of designing the light guide plate 4 to satisfy the condition that (1) assuming the use of light sources 3A, 3B having a Lambert shaped angular intensity distribution, (2) the radiated light 11a from the light guide plate 4 is converted by propagation within the downward prism sheet 5D and total internal reflection at the sloping surfaces 50a, 50b of the optical microelements 50 (with a vertex angle of 68 degrees) of the downward prism sheet 5D to light having a directional distribution localized in an angular range with a directional distribution width of approximately 30 degrees centered on 0 degrees.

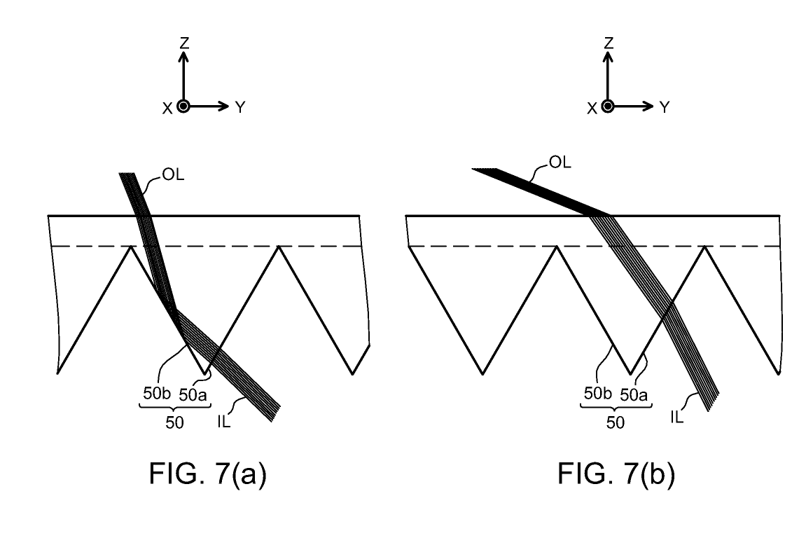

FIGS. 7(a) and 7(b) diagrammatically illustrate the optical effect of the optical microelements 50. As shown in FIG. 7(a), a bundle of incident light IL entering an optical microelement 50 through sloping surface 50a at a predetermined angle or greater with respect to the Z axis direction (mainly, radiated light 11a internally reflected in the optical microelements 40 of the light guide plate 4) undergoes total internal reflection at sloping surface 50b. The exit angle OL of the outgoing light OL is smaller than the incidence angle of the incident light IL. As shown in FIG. 7(b), a bundle of incident light IL entering the optical microelement 50 through sloping surface 50a at an angle less than the predetermined angle with respect to the Z axis direction (mainly, illumination light 12 radiated from the front surface 7b of the light guide plate 7 in the second backlight unit 2 that has passed through light guide plate 4) is refracted and radiates out in an angular direction greatly inclined from the Z axis direction. The result is that the exit angle of the outgoing light OL is greater than the incidence angle of the incident light IL. Therefore, when light with a directional distribution in which light with a predetermined intensity or greater is localized in a comparatively wide angular range centered on the Z axis direction enters from the rear surface 5a of the downward prism sheet 5D, the light can leave the downward prism sheet 5D through the front surface 5b without having its directional distribution significantly narrowed. Accordingly, the illumination light 12 radiated from the front surface 7b of light guide plate 7 is not narrowed by passage through the upward prism sheet 5V, light guide plate 4, and downward prism sheet 5D.

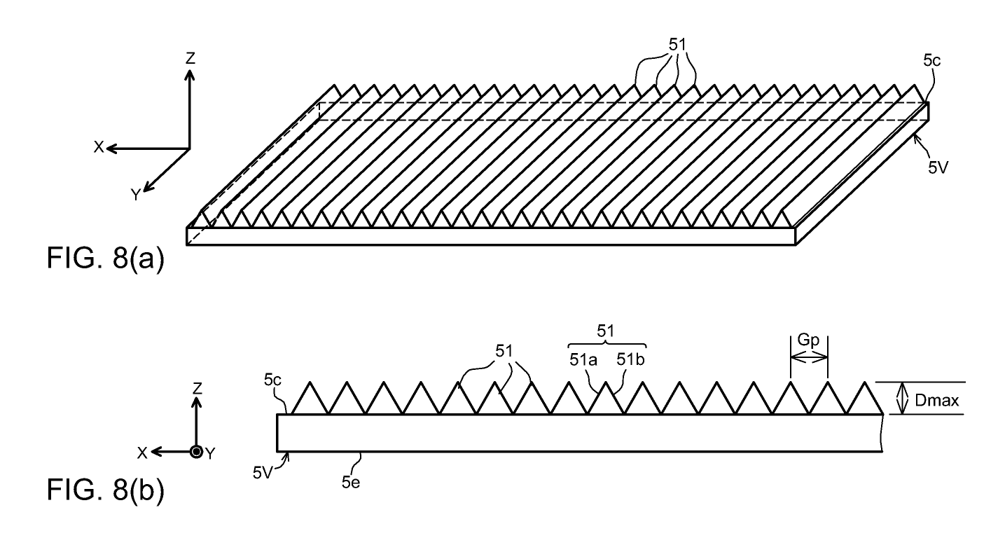

Next, the structure of the upward prism sheet 5V will be described. FIGS. 8(a) and 8(b) show a diagrammatic example of the optical structure of the upward prism sheet. FIG. 8(a) gives a diagrammatic perspective view of an exemplary structure of the surface 5c of the upward prism sheet 5V; FIG. 8(b) shows part of the structure of the upward prism sheet 5V shown in FIG. 8(a), seen from the Y axis direction. As shown in FIG. 8(a), the surface 5c of the upward prism sheet 5V (the surface facing the light guide plate 4) has a structure in which a regular array of optical microelements 51 extends in the X axis direction in a plane parallel to the display surface 10a. Each optical microelement 51 is formed in the shape of a convex triangular prism, the vertex part of the optical microelement 51 projecting toward the liquid crystal display panel 10, the vertex line in the vertex part extending in the Y axis direction. The optical microelements 51 are regularly spaced. Each optical microelement 51 has two sloping surfaces 51a, 51b inclined from the Z axis direction in the positive X axis direction and the negative X axis direction, respectively. The array direction of the optical microelements 51 of the upward prism sheet 5V (the X axis direction) is substantially orthogonal to the array direction of the optical microelements 50 of the downward prism sheet 5D (the Y axis direction).

As an example of the optical microelements 50 of the upward prism sheet 5V, optical microelements having a refractive index of approximately 1.49 and a maximum height Dmax of approximately 0.015 mm, for example, may be used, and the vertex angle formed by the sloping surfaces 51a, 51b (the vertex angle of the isosceles triangular shapes in the cross section in FIG. 8(b)) may be 90 degrees. The center-to-center spacing Gp of the optical microelements 51 in the X axis direction may be 0.03 mm. Although the prism sheet may be made from PMMA, it is not limited to that material. Other plastic materials having good optical transparency and excellent processability, such as polycarbonate plastic materials, may be used, or glass materials may be used.

By total internal reflection at its rear surface 5e of the light (returning light) incident on the optical microelements 51 from the light guide plate 4, the upward prism sheet 5V can convert the direction of propagation of the returning light to the direction of the liquid crystal display panel 10. Light that does not satisfy the conditions for total reflection at the rear surface 4a of the light guide plate 4 and radiates in a direction oppositely away from the liquid crystal display panel 10 and light that radiates from the downward prism sheet 5D in a direction oppositely away from the liquid crystal display panel 10 can be described as light returning from the light guide plate 4. The upward prism sheet 5V can retransform such returning light into illumination light of the first backlight unit 1, thereby improving the light utilization efficiency.

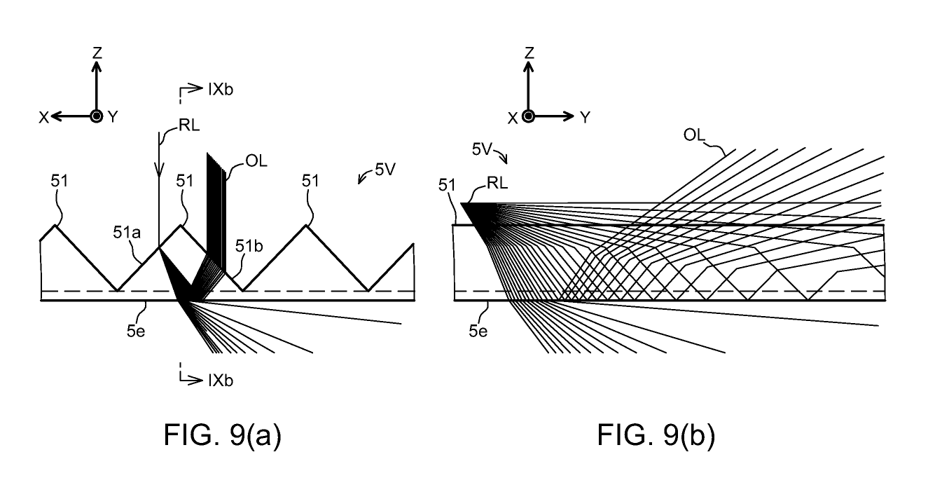

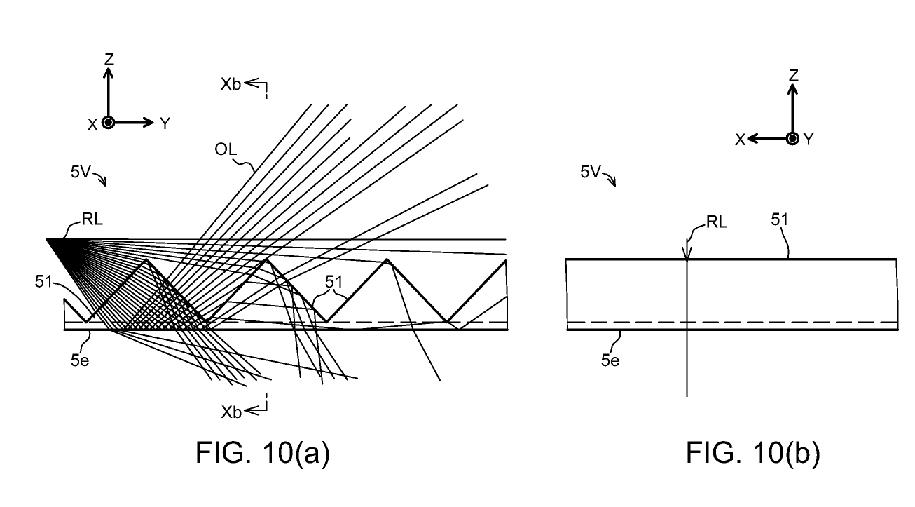

The optical effect of the optical microelements 51 will be described below. FIGS. 9(a) and 9(b) diagrammatically illustrate the optical effect of the optical microelements 51 of the upward prism sheet 5V. As noted above, the array direction of the optical microelements 51 of the upward prism sheet 5V (the X axis direction) is substantially orthogonal to the array direction of the optical microelements 50 of the downward prism sheet 5D (the Y axis direction). FIG. 9(a) shows a diagrammatic partial cross section of the upward prism sheet 5V having optical microelements 51 parallel to the X-Z plane; FIG. 9(b) is a partial sectional diagram of the upward prism sheet 5V through line IXb-IXb in FIG. 9(a). FIGS. 10(a) and 10(b) diagrammatically illustrate the optical effect of the optical microelements 51 when the upward prism sheet 5V is reoriented so that the array direction of the optical microelements 51 is parallel to the array direction of the optical microelements 50 of the downward prism sheet 5D. FIG. 10(a) shows a diagrammatic partial cross section of the upward prism sheet 5V parallel to the Y-Z plane; FIG. 10(b) is a partial sectional diagram of the upward prism sheet 5V through line Xb-Xb in FIG. 10(a). FIGS. 9(a) and 9(b) and FIGS. 10(a) and 10(b) illustrate the optical behavior when returning light RL from the light guide plate 4 enters the optical microelements 51. Since the behavior of light propagating parallel to the Y-Z plane is dominant in the actual returning light from the light guide plate 4, for convenience of description, only returning light RL propagating in a plane parallel to the Y-Z plane is shown, schematically.

As shown in FIG. 9(a), each optical microelement 51 has a pair of sloping surfaces 51a, 51b having an apex angle symmetric about the Z axis in the X-Z plane. As shown in FIGS. 9(a) and 9(b), rays of returning light RL enter sloping surface 51a of the optical microelement 51 at various angles of incidence. As shown in FIG. 9(a), light incident in the Z axis direction is refracted in the negative X axis direction by sloping surface 51a. Although not shown in the drawings, returning light RL is also incident on sloping surface 51b and is refracted in the positive X axis direction. The refracted light propagating within the upward prism sheet 5V therefore has a large angle of incidence on the rear surface 5e, so the refracted light tends to satisfy the condition for total internal reflection at the interface (the rear surface 5e) between the upward prism sheet 5V and the air layer. In other words, the angle of incidence of the refracted light on the rear surface 5e tends to be equal to or greater than the critical angle. Of the refracted light, the light OL that is totally internally reflected at the rear surface 5e is output in the direction of the liquid crystal display panel 10, as shown in FIGS. 9(a) and 9(b). In particular, much of the light RL returning from the light guide plate 4 enters the optical microelements 51 of the upward prism sheet 5V at an angle greatly inclined from the normal direction of the upward prism sheet 5V (the Z axis direction), so it can easily satisfy the condition for total internal reflection at the rear surface 5e of the upward prism sheet 5V.

As shown in FIG. 9(a), the upward prism sheet 5V has an optical structure in which pairs of sloping surfaces 51a, 51b of the optical microelements 51 follow one another continuously in the X axis direction. As shown in FIG. 9(b), however, since each optical microelement 51 extends in the Y axis direction, in the Y-Z plane, the structure of the upward prism sheet 5V is symmetrical with respect to the Z axis direction. When refracted light propagating in the upward prism sheet 5V undergoes total internal reflection at the rear surface 5e, accordingly, it is output from the upward prism sheet 5V toward the liquid crystal display panel 10 at an angle substantially equal to the angle of incidence (with respect to the Z axis direction) of the returning light RL entering the upward prism sheet 5V. As shown in FIG. 9(b), of the returning light RL, light having a small angle of incidence (with respect to the Z axis direction) on the upward prism sheet 5V does not undergo total internal reflection at the rear surface 5e, while light having a comparatively large angle of incidence undergoes total internal reflection at the rear surface 5e and is converted to outgoing light OL. Therefore, while part of the directional distribution of the returning light RL is preserved, the propagation direction of part of the returning light RL is changed to a direction toward the liquid crystal display panel 10. The outgoing light OL is converted by passage through the light guide plate 4 to light having a directional distribution necessary for conversion to illumination light 11 with a narrow-angle directional distribution by total internal reflection by the optical microelements 50 of the downward prism sheet 5D (for example, as shown in FIG. 4, a directional distribution such that light with an intensity equal to or greater than the full width half maximum value is localized in an angular range of approximately +60 degrees to +90 degrees centered on an axis inclined at an angle of approximately +75 degrees to the Z axis direction, and an angular range of approximately −60 degrees to −90 degrees centered on an axis inclined at an angle of approximately −75 degrees to the Z axis direction).

The light thus radiated from the upward prism sheet 5V toward the liquid crystal display panel 10 passes through the light guide plate 4, enters the downward prism sheet 5D, is thereby converted to illumination light 11 having a directional distribution of narrow width and high central brightness, and illuminates the rear surface 10b of the liquid crystal display panel 10. The ratio of the amount of illumination light 11 having a narrow-angle directional distribution radiated from the first backlight unit 1 to the amount radiated from the light sources 3A, 3B in the first backlight unit 1 can thereby be increased. The amount of source light needed to secure a predetermined brightness at the display surface 10a can accordingly be reduced in comparison with the conventional amount of source light, and the power consumption of the liquid crystal display device 100 can be reduced.

If the orientation of the upward prism sheet 5V is changed so that the array direction of the optical microelements 51 is parallel to the array direction of the optical microelements 50 of the downward prism sheet 5D, however, then as shown in FIG. 10(a), the returning light RL is refracted by the optical microelements 51, and part of the refracted light undergoes total internal reflection at the rear surface 5e and is output toward the liquid crystal display panel 10. In this case too, the outgoing light OL is converted by passage through the light guide plate 4 to light having substantially the same directional distribution as the directional distribution shown in FIG. 4, but in comparison with FIGS. 9(a) and 9(b), less light is radiated from the upward prism sheet 5V toward the liquid crystal display panel 10. If the returning light RL enters an optical microelement 51 at a large angle with respect to the upward prism sheet 5V (a large angle with respect to the Z axis direction), then as shown in FIGS. 10(a) and 10(b), the direction of propagation of the light in the optical microelement 51 undergoes complex changes due to refraction and reflection. In comparison with FIG. 9(b), more of the light fails to satisfy the condition for total internal reflection at the rear surface 5e of the upward prism sheet 5V, and so more light is radiated from the rear surface 5e in the direction oppositely away from to the liquid crystal display panel 10. The amount of light that undergoes total internal reflection in the upward prism sheet 5V and is radiated toward the liquid crystal display panel 10 therefore decreases. Therefore, from the viewpoint of obtaining a large power consumption reduction effect, the array direction of the optical microelements 51 of the upward prism sheet 5V is preferably substantially orthogonal to the array direction of the optical microelements 50 of the downward prism sheet 5D.

The liquid crystal display device 100 in this embodiment has a structure in which the first backlight unit 1 and the second backlight unit 2 are overlaid one on the other, with the first backlight unit 1 interposed between the second backlight unit 2 and the liquid crystal display panel 10. Since the first backlight unit 1 must transmit the illumination light 12 with a wide-angle directional distribution radiated from the second backlight unit 2, it would not be desirable to use a light reflecting sheet having, like the light reflecting sheet 8, a low transmittance and a high reflectance as a means of reflecting the returning light RL toward the liquid crystal display panel 10 in the first backlight unit 1. Since the first backlight unit 1 does not use this type of light reflecting sheet but has an upward prism sheet 5V with an extremely high optical transmittance, it does not reduce the ratio of the light having a wide-angle directional distribution radiated from the display surface 10a of the liquid crystal display device 100 to the amount of light radiated from the light sources 6A, 6B in the second backlight unit 2 (this ratio is defined as the light utilization ratio of the second backlight unit 2) and can prevent an increase in power consumption.

Returning light propagating from the first backlight unit 1 and second backlight unit 2 is reflected toward the liquid crystal display panel 10 by the light reflecting sheet 8, enabling the light to be used as illumination light. The light incident on the front surface of the light reflecting sheet 8 is light with a wide-angle directional distribution that has been scattered by the reflective scattering structure 70 of the second backlight unit 2, however, and the light reflected toward the liquid crystal display panel 10 by the light reflecting sheet 8 is scattered when reflected from the surface of the light reflecting sheet 8 or on passage through the reflective scattering structure 70. The proportion of the light entering the first backlight unit 1 from the rear side that has the angle required for conversion to illumination light 11 with a narrow-angle directional distribution is therefore reduced. As described above, however, the upward prism sheet 5V, can output light having the directional distribution needed for conversion of light entering the downward prism sheet 5D by total internal reflection in the optical microelements 50 to illumination light 11 with a narrow-angle directional distribution. Accordingly, the use of the upward prism sheet 5V can improve the light utilization efficiency of the first backlight unit 1 by converting the returning light RL incident from the light guide plate 4 efficiently to light having a narrow-angle directional distribution centered on the direction normal to the display surface 10a of the liquid crystal display panel 10.

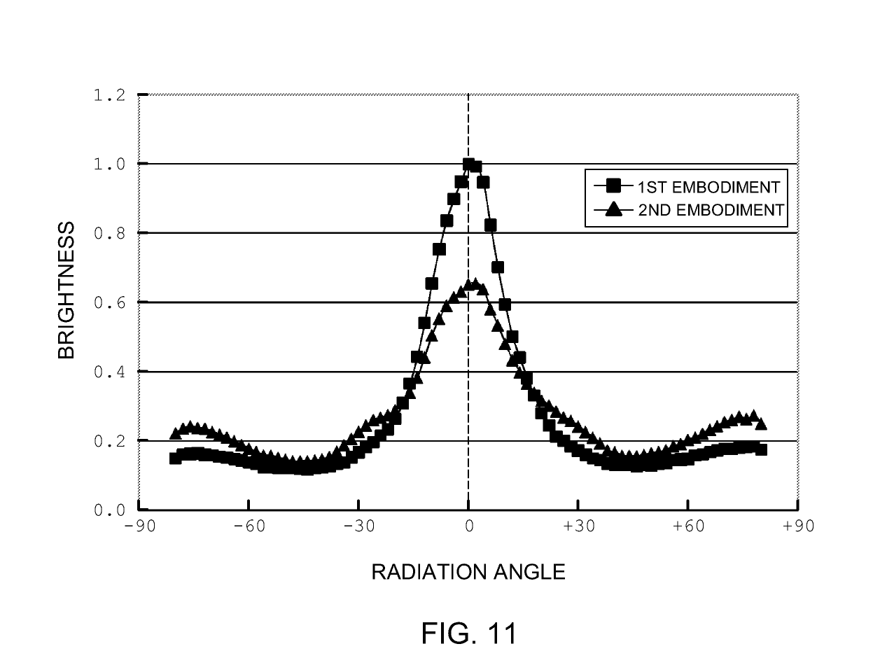

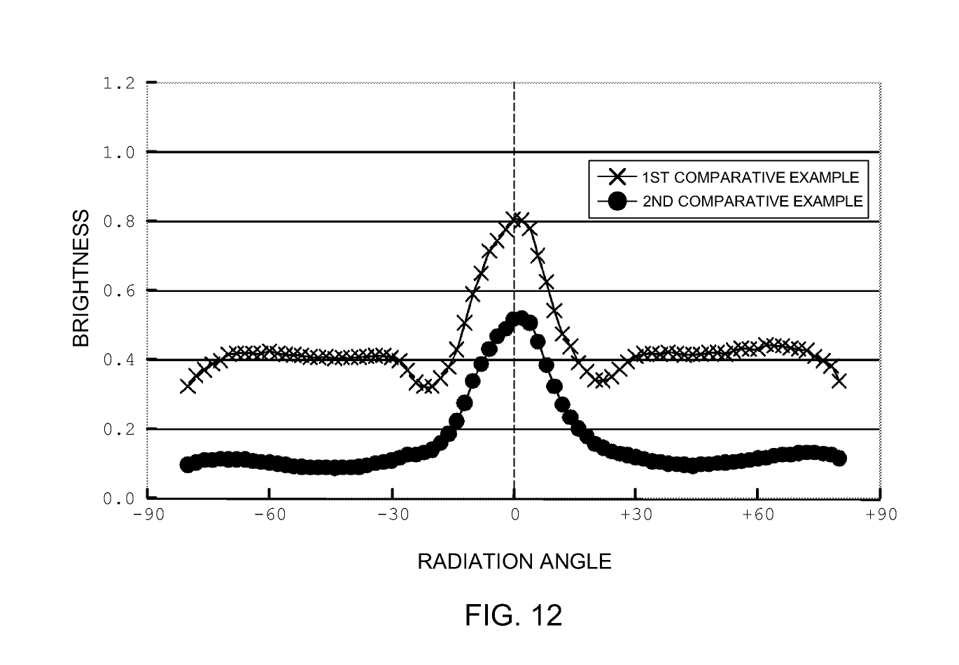

FIGS. 11 and 12 are graphs showing results of experimental measurements of the angular brightness distribution (directional distribution) of the light radiated from differently structured backlight units. In the graphs in FIGS. 11 and 12, the horizontal axis represents radiation angle and the vertical axis represents normalized brightness. The directional distribution of the light radiated toward the liquid crystal display panel 10 from the exemplary first backlight unit 1 in this embodiment (the first inventive example) and the directional distribution of the light radiated toward the liquid crystal display panel 10 from a second inventive example of a backlight unit in which the orientation of the upward prism sheet 5V is changed so that the array direction of the optical microelements 51 is parallel to the array direction of the optical microelements 50 of the downward prism sheet 5D are shown in FIG. 11. The directional distribution of light radiated toward the liquid crystal display panel 10 from a first comparative example of a backlight unit, this being a backlight unit in which the upward prism sheet 5V in the first backlight unit 1 in this embodiment is replaced with a light reflecting sheet having the same structure as light reflecting sheet 8, and the directional distribution of light radiated toward the liquid crystal display panel 10 from a second comparative example of a backlight unit, this being a backlight unit in which the upward prism sheet 5V in the first backlight unit 1 in this embodiment is replaced with a light absorbing sheet, are shown in FIG. 12. Brightness in the graphs in FIGS. 11 and 12 is normalized so that the maximum peak brightness of the directional distribution of the radiated light in the first inventive example is 1. Equal amounts of light were output from light sources 3A, 3B in the first inventive example, the second inventive example, the first comparative example, and the second comparative example in this experiment.

As is clear from FIG. 11, the amount of radiated light is greater in the first inventive example than in the second inventive example, indicating a high light utilization efficiency. As also shown in FIG. 11, in the directional distributions of radiated light in the first and second inventive examples, the brightness is adequately localized within a 30-degree angular range centered on 0 degrees (an angular range from −15 degrees to +15 degrees). As shown in FIG. 12, however, the directional distribution of radiated light in the first comparative example is not a narrow-angle directional distribution; it has a brightness of substantially 0.4 or greater in a range below −30 degrees and a range above +30 degrees. As is also clear from FIG. 12, the maximum peak brightness of the directional distribution of radiated light in the second comparative example is only about 0.5.

Next, the configuration of the second backlight unit 2 will be described. As shown in FIG. 1, the second backlight unit 2 includes light sources 6A, 6B configured similarly to the light sources 3A, 3B in the first backlight unit 1 and a light guide plate 7 that faces and substantially parallels the rear surface 4a of light guide plate 4. Light guide plate 7 is a plate-shaped member formed from a transparent optical plastic such as PMMA, and has a reflective scattering structure 70 formed on its rear surface 7a. Light sources 6A and 6B are disposed facing the edges (entrance surfaces) 7c, 7d of light guide plate 7 in the Y axis direction. As in the first backlight unit 1, light emitted from light sources 6A, 6B enters light guide plate 7 through its entrance surfaces 7c, 7d. The entering light propagates by total internal reflection within light guide plate 7, and part of the propagating light is scattered by the reflective scattering structure 70 and radiated from the front surface 7b of light guide plate 7 as illumination light 12. The reflective scattering structure 70 may be configured by, for example, coating the rear surface 7a with a reflective scattering material. Since the reflective scattering structure 70 scatters the propagating light in a wide angular range, the illumination light 12 radiated from the second backlight unit 2 is radiated toward the liquid crystal display panel 10 as illumination light having a wide-angle directional distribution.

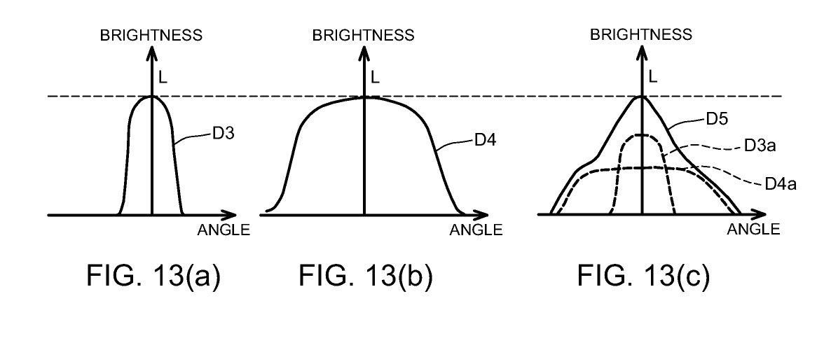

A liquid crystal display device 100 with the above configuration can make the directional distribution of the light that illuminates the rear surface 10b of the liquid crystal display panel 10 not only into a narrow-angle directional distribution or a wide-angle directional distribution but also into a directional distribution intermediate between a narrow-angle directional distribution and a wide-angle directional distribution. FIGS. 13(a), 13(b) and 13(c) show three diagrammatic examples of the directional distribution of the illumination light. When the light sources 3A, 3B in the first backlight unit 1 are turned on and the light sources 6A, 6B in the second backlight unit 2 are off, the rear surface 10b of the liquid crystal display panel 10 is illuminated by illumination light having a narrow-angle directional distribution D3 as shown in FIG. 13(a). A viewer looking straight into the liquid crystal display device 100 from the front can therefore see a bright image, but a person viewing the display surface 10a from an oblique angle sees a dark image. Since the liquid crystal display device 100 does not radiate light in unnecessary directions away from the viewer, the amount of light emitted by light sources 3A, 3B can be kept down and power consumption can be reduced.

When the light sources 6A, 6B in the second backlight unit 2 are turned on and the light sources 3A, 3B in the first backlight unit 1 are off, the rear surface of the liquid crystal display panel 10 is illuminated by illumination light having a wide-angle directional distribution D4 as shown in FIG. 13(b). The viewer can therefore see a bright image from a wide range of angular directions. To obtain adequate brightness at all of these angular directions, light sources 6A, 6B need to generate much light, and power consumption increases.

The control unit 101 in the liquid crystal display device 100 in the first embodiment therefore controls the amount of light emitted by the light sources 3A, 3B in the first backlight unit 1 and the light sources 6A, 6B in the second backlight unit 2 in response to the direction of the viewer(s). For example, as shown in FIG. 13(c), the control unit 101 can create an intermediate directional distribution D5 by having the first backlight unit 1 generate illumination light 12 and the second backlight unit 2 generate illumination light 11, so that the directional distribution D3a of illumination light 12 and the directional distribution D4a of illumination light 11 are combined. The result is that an appropriate directional distribution D5 is obtained according to the viewing direction. A viewing angle responsive to the viewing direction is thus obtained, and light radiated in unnecessary directions can be held to a minimum. Therefore, compared with the case in which illumination light with a wide-angle directional distribution D4 is radiated to enable a bright image to be seen from a wide range of viewing directions (FIG. 13(b)), the total amount of light emitted from light sources 3A, 3B, 6A, 6B can be reduced, so a major effect in reducing power consumption can be obtained.

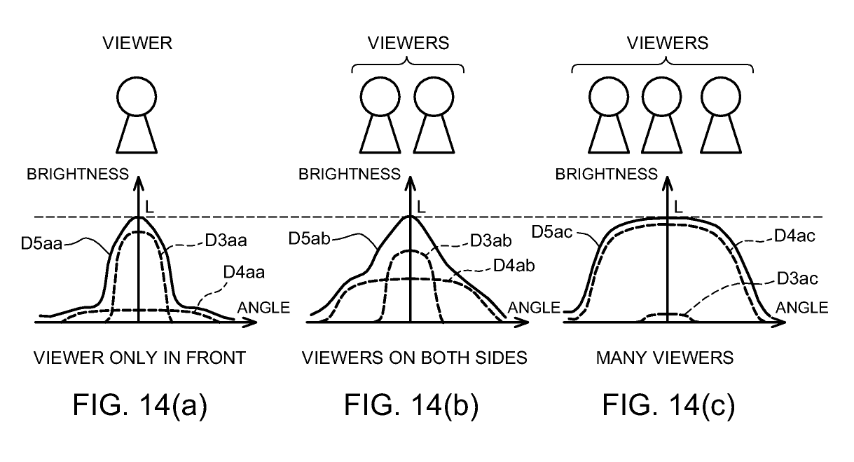

FIGS. 14(a), 14(b), and 14(c) schematically show three examples of viewing angle control. In the examples in FIGS. 14(a), 14(b), and 14(c) the viewing angle is controlled on the basis of viewer position. When the viewer is positioned directly in front of the liquid crystal display panel 10 as shown in FIG. 14(a), the control unit 101 generates a narrow angular directional distribution D5aa by setting the amount of light emitted from the first backlight unit 1 to a relatively large amount, in relation to the amount of light emitted from the second backlight unit 2, and combining the directional distribution D3aa due to the first backlight unit 1 with the directional distribution D4aa due to the second backlight unit 2 (narrow viewing angle display mode). When there are viewers positioned more widely to the right and left as shown in FIG. 14(b), the control unit 101 can generate a wide-angle directional distribution D5ab by setting the amount of light emitted from the second backlight unit 2 to a proportionally large amount in relation to the amount of light emitted from the first backlight unit 1, and combining the directional distribution D3ab due to the first backlight unit 1 with the directional distribution D4ab due to the second backlight unit 2 (first wide viewing angle display mode). When there are viewers positioned still more widely to the right and left as shown in FIG. 14(c), the control unit 101 can generate a wide angular directional distribution D5ac by setting the amount of light emitted from the second backlight unit 2 to a proportionally still larger amount in relation to the amount of light emitted from the first backlight unit 1, and combining the directional distribution D3ac due to the first backlight unit 1 with the directional distribution D4ac due to the second backlight unit 2 (second wide viewing angle display mode). Thus as the viewer positions widen to the right and left, since, in response to the widening, the control unit 101 sets the amount of light emitted from the second backlight unit 2 to a proportionally increasing amount in relation to the amount of light emitted from the first backlight unit 1, it can fine-control the viewing angle. A greater effect in reducing power consumption can also be obtained.

If the display surface 10a of the liquid crystal display device 100 is too bright, the viewer may experience glare; for this and other reasons, the brightness need not be greater than necessary. Therefore, when the control unit 101 adjusts the directional distribution of the light illuminating the rear surface 10b of the liquid crystal display panel 10 by controlling the amount of light emitted by the light sources 3A, 3B, 6A, 6B, it controls them so as to maintain the brightness (luminance) in the straight frontal direction of the liquid crystal display panel 10 at a constant value L, as shown in FIGS. 13(a) to 13(c) and 14(a) to 14(c).

The light sources 3A, 3B, 6A, 6B in the first backlight unit 1 and second backlight unit 2 are preferably light sources of the same light-emitting type. The reason is that it is then possible to avoid the possibility that differences in light emitting characteristics (emission spectrum etc.) of the light sources 3A, 3B, 6A, 6B might lead to changes in emission color when the viewing angle is changed by changing the proportional amounts of light emitted from the first backlight unit 1 and second backlight unit 2. By use of light sources performing the same type of light emission in the first backlight unit 1 and second backlight unit 2, this sort of possibility can be avoided and good image quality can be maintained when the viewing angle is changed. Light sources that may be described as light sources of the same light-emitting type include, for example, light emitters of the same structure, light emitters with the same emission wavelengths and other characteristics, light emitting modules with identical combinations of light emitters with different light emitting characteristics, and light emitters that are driven in the same way.

In a liquid crystal display device 100 having the above type of viewing angle control function, when a viewer's line of sight is greatly inclined to the direction normal to the screen, for example, when a viewer standing in a position facing the central part of the screen of a large liquid crystal display device but not adequately distanced from the liquid crystal display device looks at the peripheral parts of the screen, sufficient brightness is not obtained in the narrow viewing angle display mode and the image may be difficult to see. It is possible to avoid this problem by, for example, placing an optical sheet having a surface with a Fresnel structure or the like between backlight unit 1 and the liquid crystal display panel 10 to provide a structure that directs the direction of propagation of light at the peripheral parts of the screen toward the center of the screen.

The optical microelements 40 shown in FIGS. 3(a) and 3(b) have a convex spherical shape, but this is not a limitation. A different structure may be used for the optical microelements 40, provided the optical microelements 50 in the downward prism sheet 5D have a structure that outputs, by total internal reflection, radiated light 11a that generates illumination light 11 with a narrow-angle directional distribution.

The liquid crystal display device 100 in the first embodiment as described above can perform viewing angle control by adjusting the proportion of the amounts of light output by the first backlight unit 1 and second backlight unit 2, without using the complex and expensive active optical element described in patent document 1. The liquid crystal display device 100 can therefore hold the amount of light radiated from the display surface 10a in unnecessary directions to a minimum, so it can implement a viewing angle control function that is effective in reducing power consumption. The liquid crystal display device 100 also has a simple and inexpensive configuration that is effective for any screen size, from small to large. Since the liquid crystal display device 100 can control the amounts of light emitted by the first backlight unit 1 and second backlight unit 2 and the emission direction, it can change to an appropriate viewing angle by fine control without creating color changes or the like in the displayed image.

Illumination light 11 having a narrow-angle directional distribution can be generated by the light guide plate 4 and downward prism sheet 5D in the first backlight unit 1, without using an active optical element. As described above, the optical microelements 50 formed on the rear surface 5a of the downward prism sheet 5D can generate illumination light 11 having a narrow-angle directional distribution by total internal reflection, at the sloping surfaces 50a, 50b, of the radiated light 11a incident from the front surface 4b of the light guide plate 4.

Since the first backlight unit 1 also has an upward prism sheet 5V, even in a liquid crystal display device 100 of the layered backlight type as in this embodiment, the light utilization efficiency of the first backlight unit 1 can be improved without loss of light radiated from the second backlight unit 2. As described above, returning light RL radiated toward the rear side from the light guide plate 4 is refracted by the optical microelements 51 in the upward prism sheet 5V, then totally reflected toward the liquid crystal display panel 10 by the rear surface 5e, so that it can become illumination light 11 from the first backlight unit 1.

The illumination light 12 radiated from the second backlight unit 2 can illuminate the rear surface of the liquid crystal display panel 10 without having its directional distribution narrowed by the sloping surfaces 50a, 50b of the optical microelements 50 projecting from the rear surface. As a configuration for achieving a narrow viewing angle, a planar light source that radiates illumination light having a wide-angle directional distribution can be combined with an optical structure that converges this light and converts it to illumination light having a narrow-angle directional distribution (for example, an optical structure such that the surface on the side not facing the planar light source is the light output surface), but with this configuration, since the light output from the planar light source is converted to light with a narrow-angle directional distribution, the directional distribution of the illumination light having a wide-angle directional distribution radiated from the second backlight unit 2 is also narrowed. The optical microelements 50 in this embodiment do not converge the illumination light 12 from the second backlight unit 2 and do not narrow its wide-angle directional distribution. Therefore, even when used in a liquid crystal display device configured with a layered backlight unit having two layers or more, the configuration of this embodiment can fine-control the viewing angle.

In this embodiment, as shown in FIG. 1, light sources 3A, 3B are located at the sides of light guide plate 4 and light sources 6A, 6B are located at the sides of light guide plate 7, so even when a liquid crystal display device is configured with a layered backlight unit having two layers or more, a slim configuration with a small thickness in the Z axis direction can be realized. A thin liquid crystal display device having a viewing angle control function can therefore be realized.

The control unit 101 in the first embodiment controls the plural amounts of light of the first backlight unit 1 and second backlight unit 2 individually while maintaining the brightness in the frontal direction of the display surface 10a at a predetermined command value L, so a directional distribution of illumination light responsive to the viewing direction can be obtained without incurring more brightness than necessary. In addition, since light radiated in unnecessary directions is held to a minimum, power consumption can be greatly reduced.

The amounts of light emitted by the light sources 3A, 3B, 6A, 6B are preferably freely controllable, in order to control the directional distribution of illumination light on the rear surface of the liquid crystal display panel 10. From this viewpoint, it is preferable to use solid-state light sources such as laser light sources or light emitting diodes, the amount of light emitted by which can be easily controlled, as the light sources 3A, 3B, 6A, 6B. More appropriate viewing angle control can then be carried out.

Since the illumination light 11 radiated from the first backlight unit 1 has a narrow-angle directional distribution, as described above, the illumination light 11a radiated from the light guide plate 4 must have a directional distribution localized in an angular range greatly inclined to the normal direction (the Z axis direction) of the screen. It is desirable for the light propagating within the light guide plate 4 to be highly directional, because that simplifies control of the exit angle of the light radiated from the light guide plate 4 and enables the directional distribution to be narrowed (so that light of a predetermined intensity or greater is localized to a particular angular range). It is therefore preferable to use highly directional laser light sources as light sources 3A, 3B. Appropriate fine control of the viewing angle can then be implemented, and a greater effect in reducing power consumption can be obtained.

Although the light entrance surfaces of the light guide plate 4 in this embodiment are its two edges in the Y axis direction and light sources 3A, 3B face these two edges, the first backlight unit 1 is not limited to this configuration. The first backlight unit 1 may be configured to use only one of the two edges as a light entrance surface and have only light sources facing this edge. In this case, the surface brightness distribution of the light radiated from the light guide plate 4 is preferably evened out by appropriate modifications of the spacing or specifications of the optical microelements 40 provided on the rear surface 4a of light guide plate 4. Similarly, the second backlight unit 2 may also be configured to use only one of the two edges of light guide plate 7 as a light entrance surface and have only light sources facing this edge.

### Second Embodiment

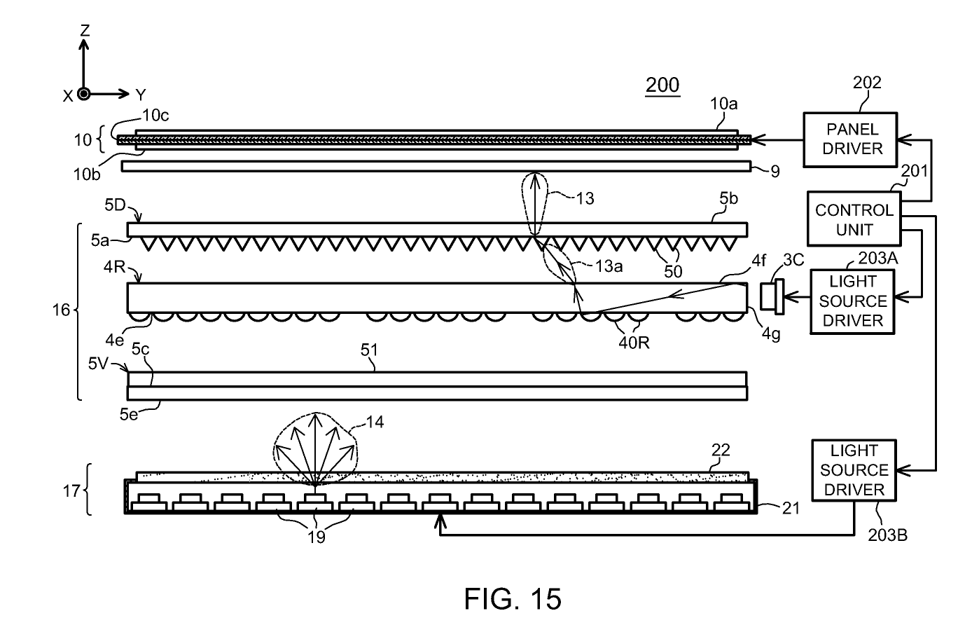

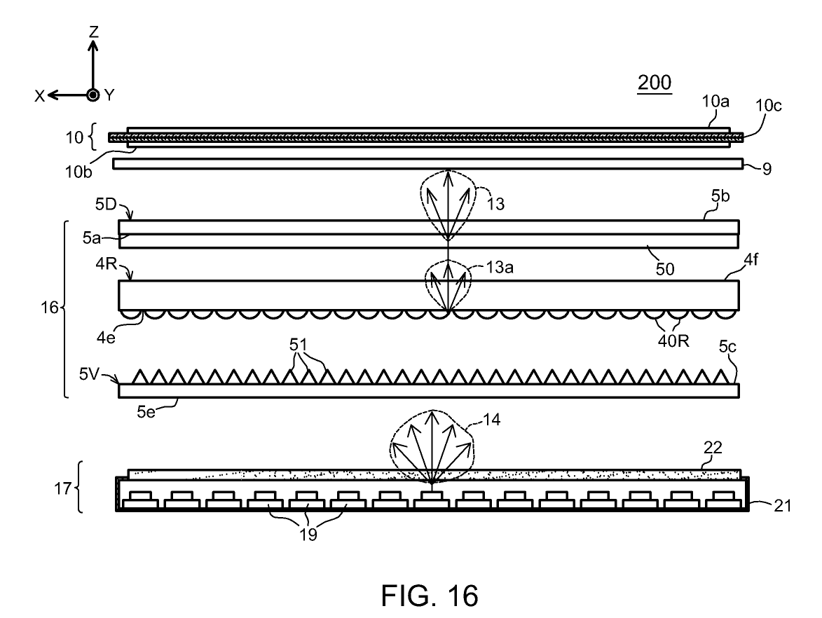

FIG. 15 schematically illustrates the structure of a liquid crystal display device (a transmissive liquid crystal display device) 200 in a second embodiment of the invention. FIG. 16 schematically illustrates part of the structure of the liquid crystal display device 200 in FIG. 15 seen from the Y axis direction. Of the component elements of the liquid crystal display device 200 in FIGS. 15 and 16, those component elements having the same reference characters as in FIG. 1 have the same functions, detailed descriptions of which will be omitted.

As shown in FIGS. 15 and 16, the liquid crystal display device 200 includes, in order on the Z axis, a liquid crystal display panel 10, an optical sheet 9, a first backlight unit 16, and a second backlight unit 17. The liquid crystal display panel 10 has a display surface 10a parallel to an X-Y plane including X and Y axes which are orthogonal to the Z axis. The X and Y axes are mutually orthogonal. The liquid crystal display device 200 also has a panel driver 202 that drives the liquid crystal display panel 10, a light source driver 203A that drives a light source 3C included in the first backlight unit 16, and a light source driver 203B that drives light sources 19 included in the second backlight unit 17. The operation of the panel driver 202 and the light source drivers 203A, 203B is controlled by a control unit 201.

The control unit 201 carries out image processing of a video signal supplied from a signal source (not shown) to generate control signals, and supplies these control signals to the panel driver 202 and light source drivers 203A, 203B. The light source drivers 203A, 203B drive the light sources 3C, 19 in response to the control signals from the control unit 201, causing the light sources 3C, 19 to emit light.

The first backlight unit 16 converts the light emitted by light source 3C to illumination light 13 with a narrow-angle directional distribution (a directional distribution in which light having a predetermined or greater intensity is localized to a comparatively narrow angular range centered on the direction normal to the display surface 10a of the liquid crystal display panel 10, i.e., the Z axis direction) and directs this light toward the rear surface of the liquid crystal display panel 10. This illumination light 13 illuminates the rear surface of the liquid crystal display panel 10 through the optical sheet 9. The second backlight unit 17 converts the light emitted by light sources 19 to illumination light 14 with a wide-angle directional distribution (a directional distribution in which light having a predetermined or greater intensity is localized to a comparatively wide angular range centered on the Z axis direction) and directs this light toward the first backlight unit 16. This illumination light 14 passes through the first backlight unit 16 and illuminates the rear surface of the liquid crystal display panel 10 through the optical sheet 9.

As shown in FIGS. 15 and 16, the first backlight unit 16 includes light source 3C, a light guide plate 4R disposed parallel to the display surface 10a of the liquid crystal display panel 10, a downward prism sheet 5D, and an upward prism sheet 5V. The first backlight unit 16 is configured by replacing the light guide plate 4 in the first backlight unit 1 in the first embodiment with light guide plate 4R. The light guide plate 4R is a plate-shaped member formed from a transparent optical material such as an acrylic plastic (PMMA). The rear surface 4e of the light guide plate 4R (the surface on the side facing away from the liquid crystal display panel 10) has a structure in which a regular array of optical microelements 40R is disposed in a plane parallel to the display surface 10a. The shape of the optical microelements 40R forms part of a spherical shape, and their surfaces have a fixed radius of curvature.

Light source 3C, which includes, for example, a plurality of light emitting diode elements arrayed in the X axis direction, is disposed facing an edge (entrance surface) 4g of the light guide plate 4R in the Y axis direction. The light emitted from light source 3C enters the light guide plate 4R through its entrance surface 4g and propagates by total internal reflection within the light guide plate 4R. Part of this light is reflected by the optical microelements 40R on the rear surface 4e of the light guide plate 4R and is emitted through the front surface (exit surface) 4f of the light guide plate 4R as illumination light 13a. The optical microelements 40R convert the light propagating through the interior of the light guide plate 4R to light having a directional distribution centered on a direction inclined at a predetermined angle from the Z axis direction, and direct this light outward through the front surface 4f. This light 13a radiated from the light guide plate 4R enters optical microelements 50 on the downward prism sheet 5D; after total internal reflection by the sloping surfaces of the optical microelements 50, the light exits through the front surface (exit surface) 5b as illumination light 13.

The optical microelements 40R may have the same shape as the optical microelements 40 in the first embodiment above. The light guide plate 4R having these optical microelements 40R may be made from the same material as the light guide plate 4 in the first embodiment. Accordingly, optical microelements having a refractive index of approximately 1.49, a maximum height of approximately 0.005 mm, and a surface with a radius of curvature of approximately 0.15 mm, for example, may be used exemplary optical microelements 40R.

The set center-to-center spacing of the optical microelements 40R decreases with increasing distance from the entrance surface 4g at which light enters from light source 3C, and increases with decreasing distance from the entrance surface 4g. As noted above, light exiting light source 3C enters the light guide plate 4R through its side entrance surface 4g. As the incident light propagates within the light guide plate 4R, it is totally reflected by the refractive index difference between the optical microelements 40R of the light guide plate 4R and an air layer, and is radiated from the front surface 4f of the light guide plate 4 toward the liquid crystal display panel 10. The optical microelements 40R are formed so that the closer they are to the entrance surface 4g near light source 3C, the more sparse they become (that is, the density of optical microelements 40R, i.e., the number per unit area, decreases with decreasing distance from the entrance surface 4g), and the farther they are from light source 3C, the more dense they become (that is, the density of optical microelements 40R, i.e., the number per unit area, increases with increasing distance from the entrance surface 4g). The reason is to obtain a uniform surface brightness distribution of the radiated light 13a. Since the light intensity increases with increasing proximity to the entrance surface 4g, the proportion of the propagating light that undergoes total internal reflection in the optical microelements 40R can be reduced by decreasing the density of the optical microelements 40R, and since the light intensity decreases with increasing distance from the entrance surface 4g, the proportion of the propagating light that undergoes total internal reflection in the optical microelements 40R can be increased by increasing the density of the optical microelements 40R. In this way, it is possible to obtain a uniform surface brightness distribution of the radiated light 13a.

As in the first embodiment above, light radiated because it does not satisfy the conditions for total reflection at the rear surface 4e of the light guide plate 4R and light radiated from the downward prism sheet 5D in a direction oppositely away from the liquid crystal display panel 10 enter the front surface 5c of the upward prism sheet 5V. The upward prism sheet 5V can change the direction of propagation of this light (returning light) to a direction toward the liquid crystal display panel 10 by total internal reflection, at the rear surface 5e, of the light returning from the light guide plate 4R that enters the optical microelements 51. The light that thus undergoes total internal reflection at the rear surface 5e is radiated toward the liquid crystal display panel 10, passes through the light guide plate 4R, and is thereby converted to light having the directional distribution necessary for conversion to illumination light 13 having a narrow-angle directional distribution by total internal reflection by the optical microelements 50 of the downward prism sheet 5D. The ratio of the amount of illumination light 13 having a narrow-angle directional distribution radiated from the first backlight unit 16 to the amount radiated from the light source 3C in the first backlight unit 16 (this ratio is defined as the light utilization ratio of the first backlight unit 16) can thereby be increased. The amount of source light needed to secure a predetermined brightness at the display surface 10a can accordingly be reduced in comparison with the conventional amount of source light, and the power consumption of the liquid crystal display device 200 can be reduced.

Next, the structure of the second backlight unit 17 will be described. As shown in FIGS. 15 and 16, the second backlight unit 17 includes a housing 21 and light sources 19 such as light emitting diodes disposed in the housing 21. These light sources 19 are disposed in a regular array in the X-Y plane in such a way that they are directly underneath the liquid crystal display panel 10. The floor of the transmissive scattering plate 22 and its inner side walls in the Y axis direction are both reflective scattering surfaces. A transmissive scattering plate 22 that transmits but scatters the light emitted from the light sources 19 is provided on the front side of the housing 21 (the side facing toward the liquid crystal display panel 10). To obtain a uniform surface distribution of the illumination light 14, this transmissive scattering plate 22 is made of a strongly scattering material. The second backlight unit 17 is thus structured as a backlight of the light source directly underneath type.

The second backlight unit 17 described above is effective as a backlight unit that must provide both a wide-angle directional distribution and a large amount of output light. Even when the liquid crystal display device 200 has a large screen, for example, adequate brightness can be obtained by use of a second backlight unit 17 of the light source directly underneath type.

When a second backlight unit 17 of the light source directly underneath type is used, if laser light sources having a small emitting area and high directionality are used as light sources 19, a complex structure is needed to obtain illumination light 14 with a uniform directional distribution. In the second embodiment, accordingly, light emitting diodes are preferably used as the light sources in the second backlight unit 17, because while light emitting diodes have the same high emission controllability as laser light sources, they are surface emitters and a uniform directional distribution of the illumination light 14 can be obtained easily. The structure of the second backlight unit 17 is thereby simplified and a cost reduction can be realized.

The light source 3C in the first backlight unit 16 and the light sources 19 in the second backlight unit 17 are preferably light sources of the same light-emitting type. The reason is that it is then possible to avoid the possibility that differences in light emitting characteristics (emission spectrum etc.) of the light sources 3C, 19 might lead to changes in emission color when the viewing angle is changed by changing the proportional amounts of light emitted from the first backlight unit 16 and second backlight unit 17.

In a liquid crystal display device 200 having the above type of viewing angle control function, when a viewer's line of sight is greatly inclined to the direction normal to the screen, for example, when a viewer standing in a position facing the central part of the screen of a large liquid crystal display device but not adequately distanced from the liquid crystal display device looks at the peripheral parts of the screen, sufficient brightness is not obtained in the narrow viewing angle display mode and the image may be difficult to see. It is possible to avoid this problem by, for example, placing an optical sheet having a surface with a Fresnel structure or the like between backlight unit 16 and the liquid crystal display panel 10 to provide a structure that directs the direction of propagation of light at the peripheral parts of the screen toward the center of the screen.

The liquid crystal display device 200 in the second embodiment as described above, like the liquid crystal display device 100 in the first embodiment, can perform viewing angle control by adjusting the proportion of the amounts of light emitted by the first backlight unit 16 and second backlight unit 17, without using a complex and expensive active optical element. The liquid crystal display device 200 can therefore hold the amount of light radiated from the display surface 10a in unnecessary directions to a minimum, so it can implement a viewing angle control function that is effective in reducing power consumption. The liquid crystal display device 200 also has a simple and inexpensive configuration that is effective for any screen size, from small to large.

As in the liquid crystal display device 100 in the first embodiment, the first backlight unit 16 has an upward prism sheet 5V. Returning light radiated from the light guide plate 4R in the first backlight unit 16 in its rear surface direction undergoes total internal reflection at the rear surface 5e of the upward prism sheet 5V, due to the presence of optical microelements 51 in the upward prism sheet 5V, and becomes illumination light 13 having a narrow-angle directional distribution. The returning light can therefore be used as part of the light radiated from the first backlight unit 16. Accordingly, even in a liquid crystal display device of the layered backlight type as in the second embodiment, the light utilization efficiency of the first backlight unit 16 can be improved without loss of light 14 radiated from the second backlight unit 17.

In addition, since the second backlight unit 17, which radiates illumination light 14 with a wide-angle directional distribution, is structured as a backlight of the light source directly underneath type, a large-screen, low-power liquid crystal display device 200 having a viewing angle control function can be realized at a low cost.

### Third Embodiment

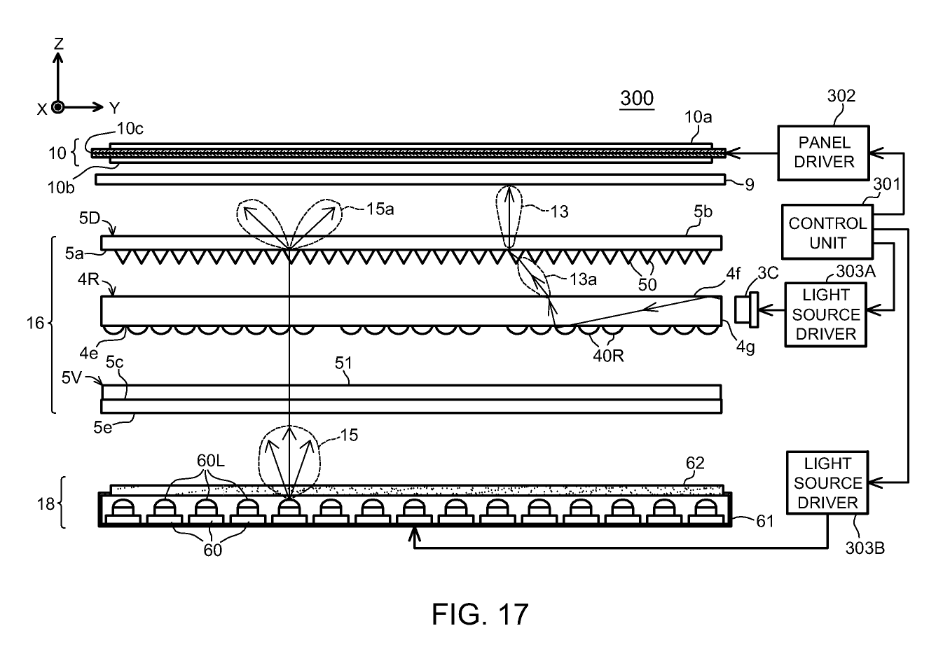

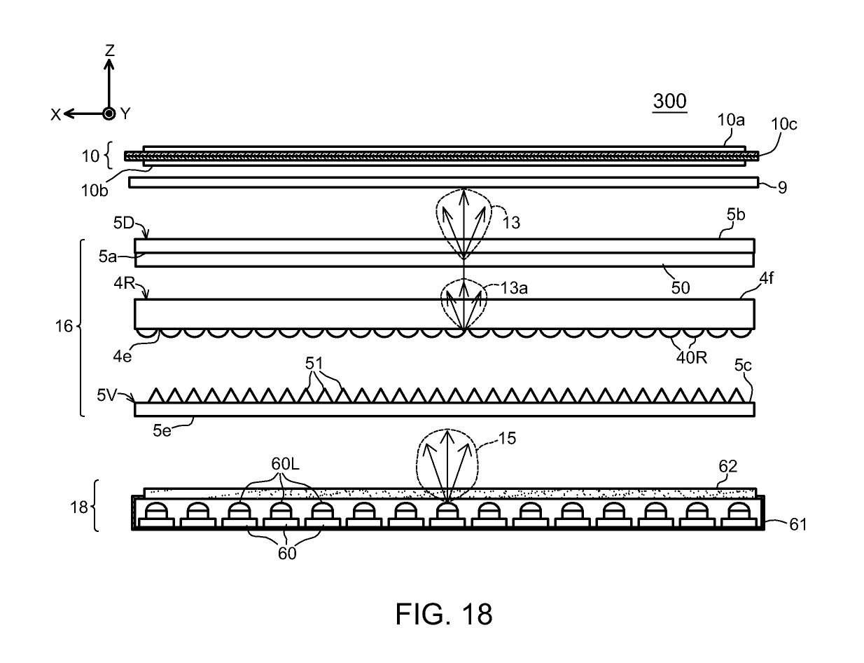

FIG. 17 schematically illustrates the structure of a liquid crystal display device (a transmissive liquid crystal display device) 300 in a third embodiment of the invention. FIG. 18 schematically illustrates part of the structure of the liquid crystal display device in FIG. 17 seen from the Y axis direction. Aside from the structure of the second backlight unit, the liquid crystal display device 300 in the third embodiment has substantially the same configuration as the liquid crystal display device 200 in the second embodiment. The special features of the third embodiment will be described in detail below. Of the component elements of the liquid crystal display device 300 in FIGS. 17 and 18, the component elements with the same reference numerals as in FIGS. 1, 2, 15, and 16 have the same functions, detailed descriptions of which will be omitted.

As shown in FIGS. 17 and 18, the liquid crystal display device 300 includes, in order on the Z axis, a liquid crystal display panel 10, an optical sheet 9, a first backlight unit 16, and a second backlight unit 18. As in the first and second embodiments, the liquid crystal display panel 10 has a display surface 10a parallel to an X-Y plane including the X and Y axes, which are orthogonal to the Z axis, the X and Y axes being mutually orthogonal. The liquid crystal display device 300 also has a panel driver 302 that drives the liquid crystal display panel 10, a light source driver 303A that drives a light source 3C included in the first backlight unit 16, and a light source driver 303B that drives light sources 60 included in the second backlight unit 18. The operation of the panel driver 302 and the light source drivers 303A, 203B is controlled by a control unit 301.

The control unit 301 carries out image processing on a video signal supplied from a signal source (not shown) to generate control signals, and supplies these control signals to the panel driver 302 and light source drivers 303A, 303B. The light source drivers 303A, 303B drive the light sources 3C, 19 in response to the control signals from the control unit 301, causing the light sources 3C, 19 to emit light.

The first backlight unit 16 converts the light emitted by light source 3C to illumination light 13 with a narrow-angle directional distribution (a directional distribution in which light having a predetermined or greater intensity is localized to a comparatively narrow angular range centered on the direction normal to the display surface 10a of the liquid crystal display panel 10, that is, the Z axis direction) and directs this light toward the rear surface of the liquid crystal display panel 10. This illumination light 11 illuminates the rear surface of the liquid crystal display panel 10 through the optical sheet 9. The second backlight unit 18 directs the illumination light 15 emitted by light sources 60, which has a comparatively narrow-angle directional distribution (a directional distribution in which light having a predetermined or greater intensity is localized to a comparatively narrow angular range centered on the Z axis direction) toward the rear surface of the first backlight unit 16. By passage through the first backlight unit 16, illumination light 15 becomes illumination light 15a having a distribution in which light having a predetermined or greater intensity is localized to comparatively narrow angular ranges centered on angles greatly inclined from the Z axis direction, and this light illuminates the rear surface of the liquid crystal display panel 10 through the optical sheet 9.

As shown in FIGS. 17 and 18, the first backlight unit 16 includes light source 3C, a light guide plate 4R oriented parallel to the display surface 10a of the liquid crystal display panel 10, a downward prism sheet 5D, and an upward prism sheet 5V, as in the second embodiment. The light guide plate 4R is a plate-shaped member formed from a transparent optical material such as an acrylic plastic (PMMA). The rear surface 4e of the light guide plate 4R (the surface on the side facing away from the liquid crystal display panel 10) has a structure in which a regular array of optical microelements 40R is disposed in a plane parallel to the display surface 10a. The shape of the optical microelements 40R forms part of a spherical shape, and their surfaces have a fixed radius of curvature.

As in the first and second embodiments, light radiated without satisfying the conditions for total reflection at the rear surface 4e of the light guide plate 4R and light radiated from the downward prism sheet 5D in a direction oppositely away from the liquid crystal display panel 10 enter the front surface 5c of the upward prism sheet 5V. The upward prism sheet 5V can change the direction of propagation of this light (returning light) returning from the light guide plate 4R that enters the optical microelements 51 to the direction toward the liquid crystal display panel 10 by total internal reflection of the light at the rear surface 5e. The light that thus undergoes total internal reflection at the rear surface 5e is radiated toward the liquid crystal display panel 10, passes through the light guide plate 4R, and is thereby converted to light having the directional distribution necessary for conversion to illumination light 13 having a narrow-angle directional distribution by total internal reflection by the optical microelements 50 of the downward prism sheet 5D. The ratio of the amount of illumination light 13 having a narrow-angle directional distribution radiated from the first backlight unit 16 to the amount radiated from the light source 3C in the first backlight unit 16 (i.e., the light utilization ratio of the first backlight unit 16) can thereby be increased. The amount of source light needed to secure a predetermined brightness at the display surface 10a can accordingly be reduced in comparison with the conventional amount of source light, and the power consumption of the liquid crystal display device 300 can be reduced.

Next, the structure of the second backlight unit 18 will be described. As shown in FIGS. 17 and 18, the second backlight unit 18 includes a housing 61 and light sources 60 such as light emitting diodes disposed in the housing 61. These light sources 60 are disposed in a regular array in the X-Y plane in such a way that they are directly underneath the liquid crystal display panel 10. The light sources 60 radiate light with a narrow directional distribution. LED light sources that radiate light having a Lambert shaped angular intensity distribution can be used. Lenses 60L are provided on the emitting surfaces of the light sources 60. This enables light with a narrow directional distribution to be generated. The light sources 60 and lenses 60L in the third embodiment radiate light having a substantially Gaussian directional distribution with a full width at half maximum (the angle of divergence with 50% of the peak power) of approximately 48 degrees in such a way that the optical axis direction of the light sources 60 and the normal direction of the liquid crystal display panel 10 are mutually parallel. The floor of the housing 61 and its inner side walls in the Y axis direction are both specular reflective surfaces. A transmissive scattering plate 62 that transmits but scatters the light emitted from the light sources 60 is provided on the front side of the housing 61 (the side facing toward the liquid crystal display panel 10). This transmissive scattering plate 62 is provided to obtain a uniform surface distribution of the illumination light 15. As the transmissive scattering plate 62, a weakly scattering plate is used to avoid excessive widening of the directional distribution of the illumination light 15 output from the second backlight unit 18. The second backlight unit 18 is structured as a backlight of the light source directly underneath type.

The illumination light 15 with a narrow-angle directional distribution radiated from the second backlight unit 18 passes through, in order, the upward prism sheet 5V, light guide plate 4R, and downward prism sheet 5D in the first backlight unit 16. As shown in FIG. 7(a), a bundle of incident light IL entering an optical microelement 50 of the downward prism sheet 5D through sloping surface 50a at a predetermined angle or greater with respect to the normal direction (Z axis direction) undergoes total internal reflection at sloping surface 50b and is radiated in the Z axis direction, or a direction inclined at a small angle to the Z axis direction. As shown in FIG. 7(b), a bundle of incident light IL entering the optical microelement 50 through sloping surface 50a at an angle less than the predetermined angle with respect to the Z axis direction is refracted and radiates out in an angular direction greatly inclined from the Z axis direction. The light 15 radiated from the second backlight unit 18 has a narrow-angle directional distribution centered on the Z axis direction. By passage through the downward prism sheet 5D, this light 15 is radiated in an angular direction greatly inclined from the Z axis direction, like the bundle of light OL shown in FIG. 7(b).

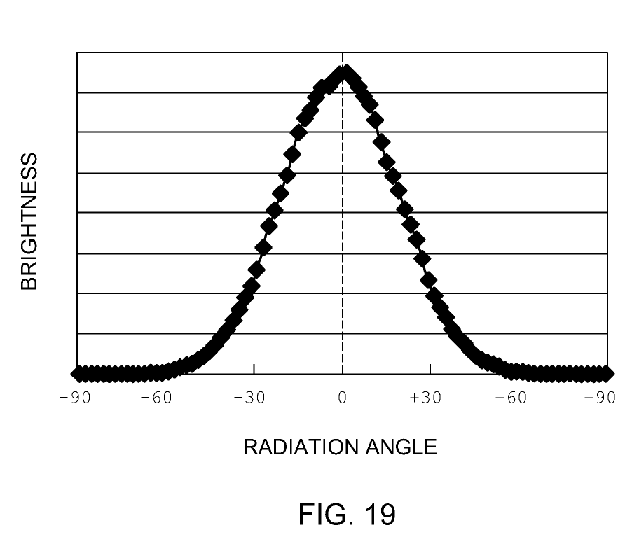

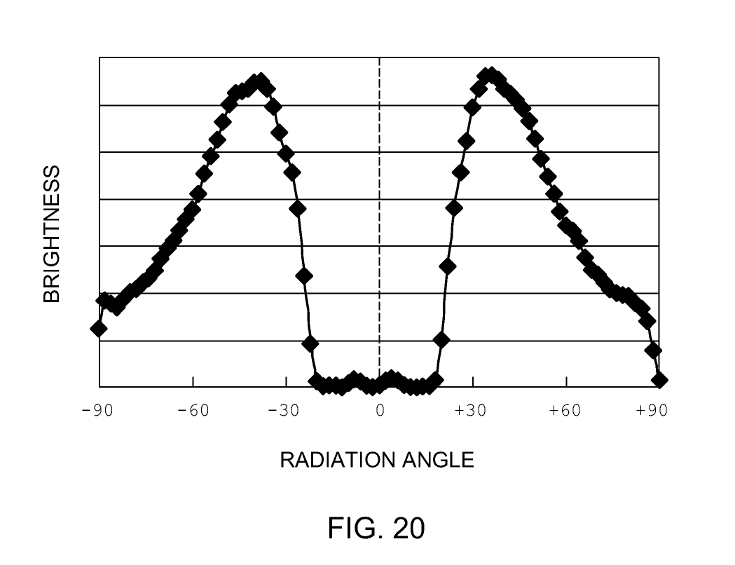

An example of the change in the directional distribution of the illumination light 15 radiated from the second backlight unit 18 before and after it passes through the downward prism sheet 5D is shown in FIGS. 19 and 20. FIG. 19 illustrates the directional distribution of the illumination light 15 radiated from the second backlight unit 18. FIG. 20 illustrates the directional distribution of the illumination light 15 obtained after the illumination light 15 has passed through the downward prism sheet 5D. In FIGS. 19 and 20, the horizontal axis indicates angle of inclination to the normal of the liquid crystal display panel 10 (the Z axis direction), and the vertical axis indicates brightness. The illumination light 15, which has a directional distribution of substantially Gaussian shape with a full width at half maximum of approximately 50 degrees as shown in FIG. 19, is converted by passage through the downward prism sheet 5D to light 15a having a directional distribution with a Z axis directional intensity having brightness peaks at approximately ±40 degrees from the Z axis direction as shown in FIG. 20.

As described above, illumination light with a narrow-angle directional distribution centered on the Z axis direction as shown in FIG. 6 is obtained by turning on only the first backlight unit 16. Illumination light 15a with a directional distribution having brightness peaks at angles shifted by an arbitrary angle from the Z axis direction as shown in FIG. 20, however, can be obtained by turning on only the second backlight unit 18.

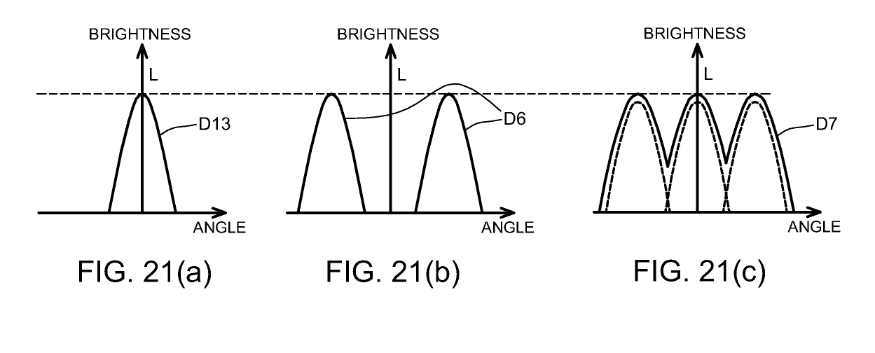

A liquid crystal display device 300 having the structure described above makes it possible to switch the directional distribution of the light illuminating the rear surface 10b of the liquid crystal display panel 10 and can optimize the position of the brightness peak of the illumination light radiated from the entire surface 10a. FIGS. 21(a), 21(b), and 21(c) show three diagrammatic examples of the directional distribution of the illumination light. When the light source 3C in the first backlight unit 16 is on and the light sources 60 in the second backlight unit 18 are off, the rear surface 10b of the liquid crystal display panel 10 is illuminated by illumination light having a narrow-angle directional distribution D13 as shown in FIG. 21(a). A viewer looking straight into the liquid crystal display device 300 from the front can therefore see a bright image, but a person viewing the display surface 10a from an oblique angle sees a dark image. Since the liquid crystal display device 300 does not radiate light in unnecessary directions away from the viewer, the amount of light emitted by light source 3C can be kept down and power consumption can be reduced.

When the light sources 60 in the second backlight unit 18 are turned on and the light source 3C in the first backlight unit 16 is off, the rear surface of the liquid crystal display panel 10 is illuminated by illumination light 15a having a directional distribution D6 with brightness peaks at an arbitrary angle as shown in FIG. 21(b). A viewer can see a bright image from the arbitrary angle, but when the display surface 10a is viewed from other directions a dark image is seen. Since the liquid crystal display device 300 does not radiate light in unnecessary directions away from the viewer, the amount of light emitted by light sources 60 can be kept down and power consumption can be reduced.

By turning on both the first backlight unit 16 and the second backlight unit 18, the liquid crystal display device 300 in the third embodiment enables viewers to see a bright image from a plurality of directions, but when the display surface 10a is viewed from other directions a dark image is seen (FIG. 21(c), for example). In comparison with radiating illumination light with a wide-angle directional distribution, in which light is present continuously across a wide angle to enable the image to be seen from all angles, the total amount of emitted light can be reduced, so a power consumption reduction effect can be obtained.

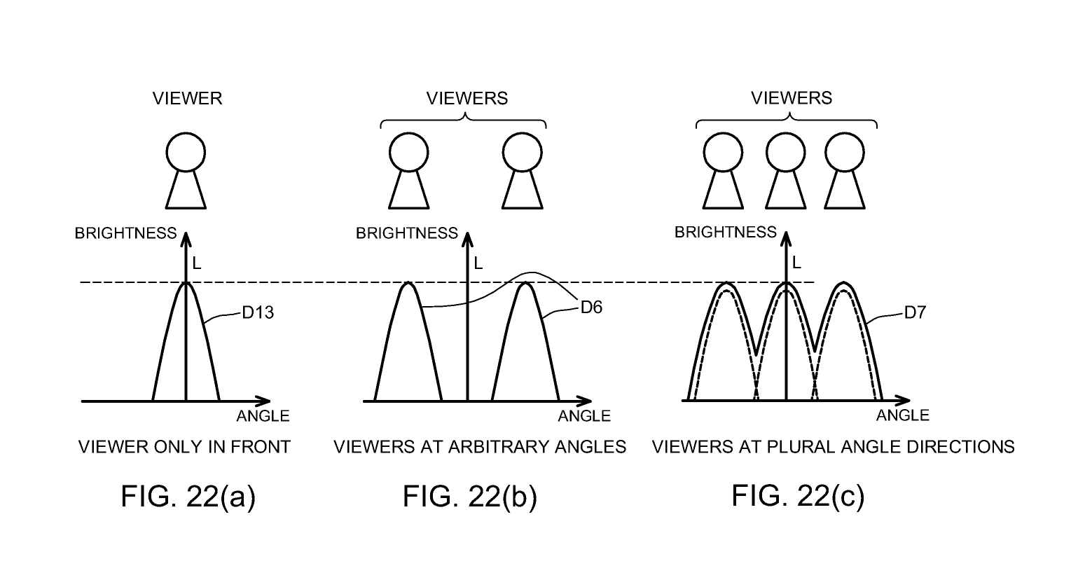

FIGS. 22(a), 22(b), and 22(c) schematically show three examples of viewing angle control. In the examples in FIGS. 22(a) to 22(c), the viewing angle is controlled on the basis of viewer position. When there is only a viewer positioned directly in front of the liquid crystal display panel 10 as shown in FIG. 22(a), the control unit 301 generates the directional distribution D13 that enables viewing only from the directly frontal position, by having the first backlight unit 16 emit light (frontal display mode). When there are only viewers positioned in directions at an arbitrary angle to the frontal direction as shown in FIG. 22(b), the control unit 301 generates the directional distribution D6 that enables viewing only from positions to the side of the frontal direction, by having the second backlight unit 18 emit light (side display mode). When there are viewers positioned both directly in front and at positions to the sides as shown in FIG. 22(c), the control unit 301 generates the directional distribution D7 that enables viewing by viewers positioned both directly in front and to the sides, by having both the first and second backlight units 16, 18 emit light (front and side display mode). In this way, the control unit 301 sets the optimum amount of light emitted by the first and second backlight units 16, 18, so unnecessary illumination is eliminated and a great effect in reducing power consumption is obtained.

Unnecessary illumination is eliminated and a great effect in reducing power consumption is obtained because the liquid crystal display device 300 in the third embodiment can switch to the optimal backlight illumination mode for the position(s) of the viewer(s). The viewing angle control function in the third embodiment is particularly effective in, for example, vehicle-mounted displays, game machine displays, and the like, in which the positional relation of the viewer(s) to the display surface 10a is to some extent fixed.

The directions of the peak brightness positions in the side display mode are directions inclined at angles of ±40 degrees to the normal direction of the liquid crystal display panel 10 in the third embodiment, but the invention is not limited to this angle. The brightness peaks can be set to desired angles by changing the directional distribution of the light radiated from the second backlight unit 18, and changing the shape of the optical microelements 50 of the downward prism sheet 5D.

In both the frontal display mode and the side display mode, the third embodiment narrows the directional distribution so as to provide high visibility in only the necessary directions, visibility in unnecessary directions being low, but the invention is not limited to this scheme. The directional distributions may be widened to improve visibility not only in the necessary directions but also in neighboring directions. The directional distribution in the frontal display mode can be widened by changing the directional distribution of light source 3C and changing the shape of the optical microelements 40R formed on the rear surface of the light guide plate 4R. The directional distribution in the side display mode can be widened by changing the directional distribution of the illumination light 15 radiated from the second backlight unit 18 and changing the shape of the optical microelements 50 on the downward prism sheet 5D. Then when the first backlight unit 16 and second backlight unit 18 are both turned on, the control unit 301 can adjust the brightness by controlling the amounts of light emitted by the first backlight unit 16 and second backlight unit 18 individually, taking into consideration the effect of the light radiated by one of the first backlight unit 16 and second backlight unit 18 on the light emitted by the other unit. In applications in which the positional relation of the viewer(s) to the display surface 10a is fixed and visibility from a narrow angular range suffices, however, a greater effect in reducing power consumption can be obtained by narrowing the directional distributions in each mode.

In the third embodiment, since the upward prism sheet 5V is placed between the first backlight unit 16 and second backlight unit 18 so that the direction of its prism vertex lines is substantially orthogonal to the direction of the prism vertex lines of the downward prism sheet 5D, light radiated from the first backlight unit 16 in its rear surface direction (the direction of the side facing away from the liquid crystal display panel 10) is completely reflected by the downward prism sheet 5D. It is also reused as light from the first backlight unit 16, its direction of propagation in the Y-Z plane being preserved. The light utilization efficiency of the first backlight unit 16 is accordingly improved, and a further effect in reducing power consumption is obtained.

The inner side walls and the inner floor surface of the housing 61 of the second backlight unit 2 are specular reflecting surfaces in the third embodiment. This is in order to convert light radiated from the second backlight unit 18 in its rear surface direction (the direction of the side facing away from the liquid crystal display panel 10) to light propagating toward the liquid crystal display panel 10 with its direction of propagation preserved, and to reuse the light as light of the second backlight unit 18 in which light having a predetermined or greater intensity is localized to a comparatively narrow angular range centered on the Z axis direction. The light utilization efficiency of the second backlight unit 18 can be improved in this way, and a further effect in reducing power consumption is obtained.

In the third embodiment, as light sources 60, the second backlight unit 18 has light emitting diodes that radiate light having a narrow-angle directional distribution. These light sources 60 are arranged in a regular array in the X-Y plane and are positioned directly underneath the liquid crystal display panel 10. The second backlight unit 18 is therefore configured as a backlight of the light source directly underneath type, but the present invention is not limited to this type of backlight. The so-called sidelight type, for example, in which light enters from the side edge of a light guide (not shown), can be used, and the light guide may be provided with optical microelements on its light exit surface. This type of backlight can be configured to radiate light, that has entered the light guide from the light source (not shown), toward the rear surface of the first backlight unit 16 as light having a directional distribution in which light of a predetermined or greater intensity is localized to a comparatively narrow angular range centered on the Z axis direction.

The light source 3C in the first backlight unit 1 and the light sources 60 in the second backlight unit 2 are preferably light sources of the same light-emitting type. The reason is that it is then possible to avoid the possibility that differences in light emitting characteristics (emission spectrum etc.) of the light sources 3C, 60 might lead to changes in emission color when the viewing angle is changed by changing the proportional amounts of light emitted from the first backlight unit 1 and second backlight unit 2.

The liquid crystal display device 300 in the third embodiment as described above can perform viewing angle control by adjusting the proportion of the amounts of light emitted by the first backlight unit 16 and second backlight unit 18, without using a complex and expensive active optical element. The liquid crystal display device 300 can therefore hold the amount of light radiated from the display surface 10a in unnecessary directions to a minimum, so it can implement a viewing angle control function that is effective in reducing power consumption. The liquid crystal display device 300 also has a simple and inexpensive configuration that is effective for any screen size, from small to large.

As in the liquid crystal display devices 100, 200 in the first and second embodiments, the first backlight unit 16 has an upward prism sheet 5V. Returning light radiated from the light guide plate 4R in the first backlight unit 16 in its rear surface direction undergoes total internal reflection at the rear surface 5e of the upward prism sheet 5V, due to the presence of optical microelements 51 in the upward prism sheet 5V, and becomes illumination light 13 having a narrow-angle directional distribution. The returning light can therefore be used as part of the light radiated from the first backlight unit 16. Accordingly, even in a liquid crystal display device 300 of the layered backlight type as in the third embodiment, the light utilization efficiency of the first backlight unit 16 can be improved without loss of light 14 radiated from the second backlight unit 17.

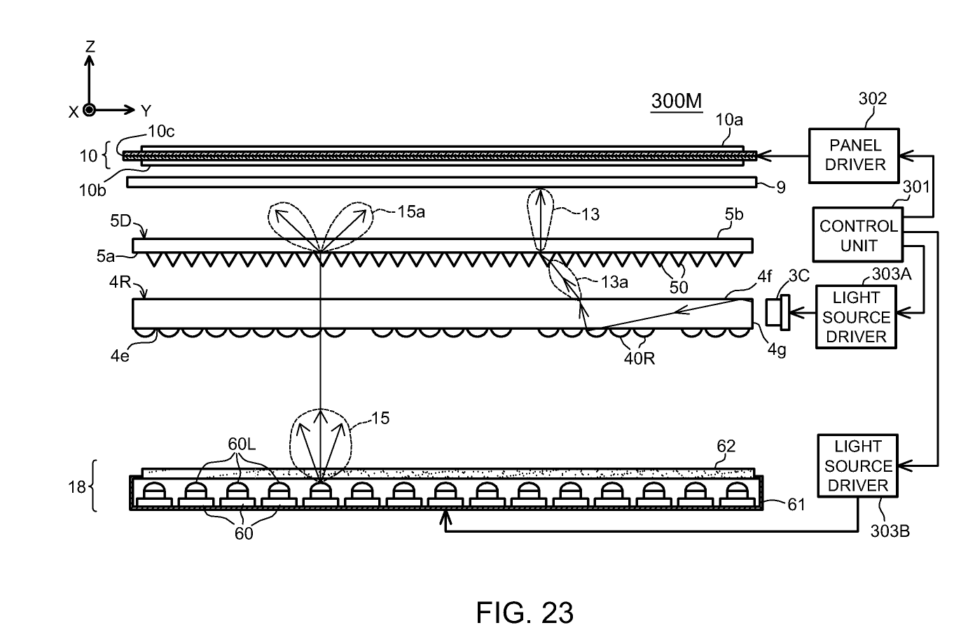

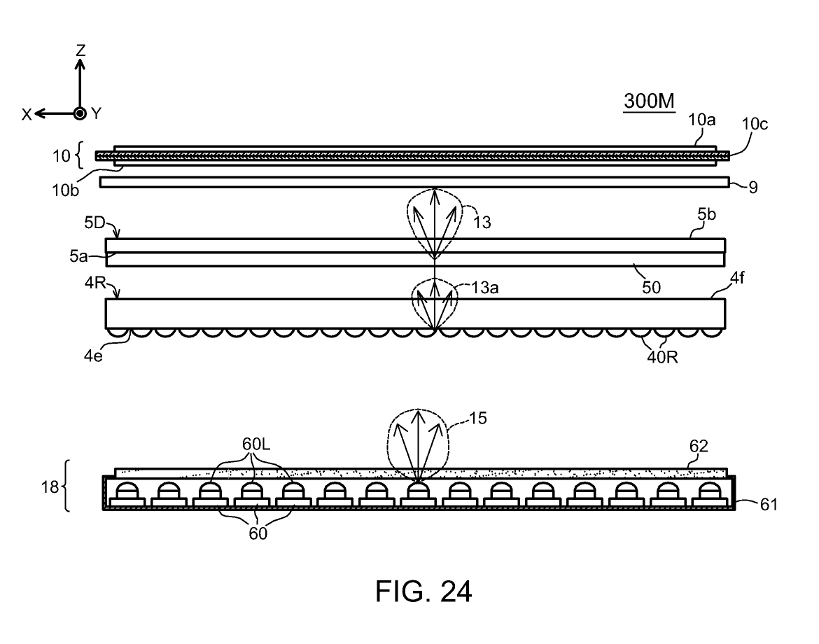

The liquid crystal display device 300 in the third embodiment is provided with an upward prism sheet 5V to improve the light utilization efficiency of the first backlight unit 1, but this is not a limitation. Embodiments in which the liquid crystal display unit 300M lacks an upward prism sheet 5V are also possible, as shown in FIGS. 23 and 24. FIG. 23 schematically illustrates the structure of a liquid crystal display device (a transmissive liquid crystal display device) 300M in a variation of the third embodiment of the invention; FIG. 24 schematically illustrates part of the structure of the liquid crystal display device in FIG. 23 seen from the Y axis direction. Even in the configuration shown in FIGS. 23 and 24, it is possible to obtain illumination light 13 having directional distribution D13 from the first backlight unit 16 and illumination light 15a having directional distribution D6 from the second backlight unit 18. By control of the emitted amounts of illumination light 13 and 15a, a liquid crystal display device 300M with a variable viewing angle that can reduce power consumption can be realized.

Variations of the First, Second, and Third Embodiments

Although various embodiments of the invention have been described above with reference to the drawings, these embodiments only exemplify the invention; a variety of configurations other than those described above may be used. For example, the shape of the optical microelements 50 is not limited to the triangular prism shape shown in FIGS. 5(a) and 5(b). As noted above, the shape of the optical microelements 50 is determined in combination with the light guide plate 4. Shapes other than a triangular prism shape may be used if the principle rays of the light radiated from the front surface 4b of the light guide plate 4 and incident on the downward prism sheet 5D are converted to illumination light 11 with a narrow-angle directional distribution by total internal reflection in the optical microelements 50.

For another example, the upward prism sheet 5V is not limited to having optical microelements 51 with a convex triangular prism shape as shown in FIGS. 8(a) and 8(b). An optical sheet or plate member having other optical microelements with no structure in the plane (the Y-Z plane in the drawings) in which the optical microelements 50 of the downward prism sheet 5D have sloping parts but with a structure in a plane (the Z-X plane in the drawings) orthogonal to that plane may be used. Since the light radiated from the second backlight unit 2, 17, or 18 must pass through this type of optical sheet or plate member, however, it is necessary to form a structure in the optical sheet or plate member that takes account of the optical effects it will be subject to in the Z-X plane in the drawings. The upward prism sheets 5V in the first, second, and third embodiments have structures that focus light from the second backlight unit in a direction orthogonal to the viewing angle control direction. This narrows the directional distribution in directions in which a wide field of view is not necessary, enabling improved brightness or a power consumption reduction effect to be obtained.

Although the liquid crystal display devices 100, 200 in the first and second embodiments have an upward prism sheet 5V, embodiments in which there is no upward prism sheet 5V are also possible. Moreover, the invention is not limited to the preferred configuration of the first backlight units 1, 16 in the first, second, and third embodiments, in which the array direction of the optical microelements 51 of the upward prism sheet 5V is substantially orthogonal to the array direction of the optical microelements 50 of the downward prism sheet 5D. Even if the angle formed by the array direction of the optical microelements 51 of the upward prism sheet 5V and the array direction of the optical microelements 50 of the downward prism sheet 5D departs somewhat from 90 degrees, the light utilization efficiency of the first backlight unit 1 or 16 can still be improved as compared with the case in which there is no upward prism sheet 5V.

As described above, the liquid crystal display devices 100, 200, 300 in the first, second, and third embodiments can carry out fine control of the viewing angle regardless of the screen size. The optimal viewing angle for the number of viewers and their viewing positions can therefore by selected, and a power consumption reduction effect can be obtained by not wasting illumination light. It is also possible to implement a function in the liquid crystal display devices 100, 200, 300 that creates a private mode such that normally, the display has a wide viewing angle with improved visibility for the viewer and his or her surrounding vicinity, but at other times the wide viewing angle is switched over to a narrow viewing angle so that the display cannot be seen from the surrounding vicinity.

### REFERENCE CHARACTERS

100, 200, 300 liquid crystal display device; 1, 16 first backlight unit; 2, 17, 18 second backlight unit; 3A, 3B, 6A, 6B, 3C, 19, 60 light source; 60L lens; 4, 4R guide plate; 40, 40R, 50, 51 optical microelement; 5D downward prism sheet; 5V upward prism sheet; 7 light guide plate; 70 reflective scattering structure; 8 light reflecting sheet; 9 optical sheet; 10 liquid crystal display panel; 21, 61 housing; 22, 62 transmissive scattering plate (transmissive scattering structure).

1-21. (canceled)

22. A liquid crystal display device comprising:
a liquid crystal display panel having a rear surface and a display surface on a side opposite the rear surface, for modulating light entering from the rear surface to generate image light and outputting the image light from the display surface;
a first backlight unit for illuminating the rear surface of the liquid crystal display panel with light;
a second backlight unit for radiating light toward a rear surface of the first backlight unit;
a first light source driving and control unit for controlling the amount of light emitted by the first backlight unit; and
a second light source driving and control unit for controlling the amount of light emitted by the second backlight unit; wherein
the first backlight unit includes
a first light source controlled by the first light source driving and control unit,
a first optical member for transmitting the light radiated by the second backlight unit, and for converting light output by the first light source to light having a narrow-angle directional distribution in which light having a predetermined or greater intensity is localized to a first angular range centered on a direction normal to the display surface of the liquid crystal display panel and radiating the converted light toward the liquid crystal display panel, and
a first optical sheet for transmitting the light radiated by the second backlight unit and for reflecting, toward the first optical member, by total internal reflection, light radiated from a side of the first optical member facing oppositely away from the liquid crystal display panel;
the second backlight unit includes
a second light source controlled by the second light source driving and control unit, and
a second optical member for converting light output from the second light source to light having a wide-angle directional distribution in which light having a predetermined or greater intensity is localized to a second angular range wider than the first angular range, and radiating the converted light toward the rear surface of the first backlight unit; and
the first optical member and the first optical sheet transmit the light radiated from the second optical member without narrowing the wide-angle directional distribution of the light radiated from the second optical member.

23. The liquid crystal display device of claim 22, wherein the first optical member includes:
a light guide plate for converting light output from the first light source to light having a directional distribution in which light having a predetermined or greater intensity is localized to an angular range centered on a direction inclined at a predetermined angle from a direction normal to the display surface, and radiating the converted light toward the liquid crystal display panel; and
a second optical sheet having a rear surface on a side facing oppositely away from the liquid crystal display panel, the rear surface of the second optical sheet having a structure in which a plurality of first optical microelements are arranged in a regular array in a plane orthogonal to the direction normal to the display surface, each of the first optical microelements having a sloping surface inclined from the direction normal to the display surface, wherein
the second optical sheet converts the light having the directional distribution radiated from the light guide plate to the light having the narrow-angle directional distribution by total internal reflection at the sloping surfaces of the first optical microelements.

24. A liquid crystal display device comprising:
a liquid crystal display panel having a rear surface and a display surface on a side opposite the rear surface, for modulating light entering from the rear surface to generate image light and outputting the image light from the display surface;
a first backlight unit for illuminating the rear surface of the liquid crystal display panel with light;
a second backlight unit for radiating light toward a rear surface of the first backlight unit;
a first light source driving and control unit for controlling the amount of light emitted by the first backlight unit; and
a second light source driving and control unit for controlling the amount of light emitted by the second backlight unit; wherein
the first backlight unit includes
a first light source controlled by the first light source driving and control unit, and
a first optical member for transmitting the light radiated by the second backlight unit, and for converting light output by the first light source to light having a first directional distribution in which light having a predetermined or greater intensity is localized to a first angular range centered on a direction normal to the display surface of the liquid crystal display panel and radiating the converted light toward the liquid crystal display panel;
the second backlight unit includes
a second light source controlled by the second light source driving and control unit, and
a second optical member for converting light output from the second light source to light having a second directional distribution in which light having a predetermined or greater intensity is localized to a second angular range centered on the direction normal to the display surface of the liquid crystal display panel, and radiating the converted light toward the rear surface of the first backlight unit; and
the first optical member converts the light radiated from the second optical member to light having a third directional distribution in which light having a predetermined or greater intensity is localized to a third angular range centered on a direction inclined at a predetermined angle from the direction normal to the display surface of the liquid crystal display panel, and radiates the converted light toward the liquid crystal display panel.

25. The liquid crystal display device of claim 24, wherein the first backlight unit further includes a first optical sheet for transmitting the light radiated by the second backlight unit and for reflecting, toward the first optical member, by total internal reflection, light radiated from a side of the first optical member facing oppositely away from the liquid crystal display panel.

26. The liquid crystal display device of claim 24, wherein the first optical member includes:
a light guide plate for converting light output from the first light source to light having a fourth directional distribution in which light having a predetermined or greater intensity is localized to a fourth angular range centered on a direction inclined at a predetermined angle from a direction normal to the display surface, and radiating the converted light toward the liquid crystal display panel; and
a second optical sheet for converting the light having the fourth directional distribution radiated from the light guide plate toward the liquid crystal display panel to the light having the first directional distribution, and for converting the light having the second directional distribution radiated from the second optical member toward the liquid crystal display panel to the light having the third directional distribution; wherein:
a rear surface of the second optical sheet has a structure in which a plurality of first optical microelements are arranged in a regular array in a plane orthogonal to the direction normal to the display surface, each of the first optical microelements having a sloping surface inclined from the direction normal to the display surface; and
the second optical sheet converts light entering from the rear surface of the second optical sheet at a predetermined angle or greater to the direction normal to the display surface to light having a directional distribution in which light having a predetermined or greater intensity is localized in an angular range centered on the direction normal to the display surface by means of the first optical microelements and radiates the converted light toward the liquid crystal display panel, and converts light entering from the rear surface of the second optical sheet at less than the predetermined angle to the direction normal to the display surface to light having a directional distribution in which light having a predetermined or greater intensity is localized in an angular range centered on a direction inclined at a predetermined angle to the direction normal to the display surface by means of the first optical microelements and radiates the converted light toward the liquid crystal display panel.

27. The liquid crystal display device of claim 26, wherein the first optical microelements comprise projecting parts having triangular prism shapes projecting oppositely away from the liquid crystal display panel, with vertex lines extending parallel to the display surface.

28. The liquid crystal display device of claim 26, wherein the fourth angular range of the fourth directional distribution of the light radiated from the light guide plate is a range from +60 degrees to +90 degrees and from −60 degrees to −90 degrees with respect to the direction normal to the display surface.

29. The liquid crystal display device of claim 25, wherein:
a surface of the first optical sheet facing toward the liquid crystal display panel has a structure in which a plurality of third optical microelements projecting toward the liquid crystal display panel are arranged in a regular array;
each of the third optical microelements has a sloping surface inclined from the direction normal to the display surface; and
the first optical sheet has a rear surface that totally reflects, toward the liquid crystal display panel, light refracted by the sloping surfaces of the third optical microelements.

30. The liquid crystal display device of claim 29, wherein the third optical microelements comprise projecting parts having triangular prism shapes with vertex lines parallel to the display surface.

31. The liquid crystal display device of claim 24, wherein by controlling the first light source and the second light source, the first light source driving and control unit and the second light source driving and control unit maintain a constant brightness in the direction normal to the display surface.

32. The liquid crystal display device of claim 22, wherein:
a surface of the first optical sheet facing toward the liquid crystal display panel has a structure in which a plurality of third optical microelements projecting toward the liquid crystal display panel are arranged in a regular array;
each of the third optical microelements has a sloping surface inclined from the direction normal to the display surface; and
the first optical sheet has a rear surface that totally reflects, toward the liquid crystal display panel, light refracted by the sloping surfaces of the third optical microelements.

33. The liquid crystal display device of claim 23, wherein the light having the directional distribution enters into the second optical sheet from the sloping surfaces of the first optical microelements.

34. The liquid crystal display device of claim 23, wherein:
a surface of the first optical sheet facing toward the liquid crystal display panel has a structure in which a plurality of third optical microelements projecting toward the liquid crystal display panel are arranged in a regular array;
each of the third optical microelements has a sloping surface inclined from the direction normal to the display surface;
the first optical sheet has a rear surface that totally reflects, toward the liquid crystal display panel, light refracted by the sloping surfaces of the third optical microelements;
the sloping surfaces of the first optical microelements extend in a first extending direction along the rear surface of the second optical sheet; and
the sloping surfaces of the third optical microelements extend in a second extending direction along the rear surface of the first optical sheet, the second extending direction crossing the first extending direction.

35. The liquid crystal display device of claim 32, wherein the third optical microelements comprise projecting parts having triangular prism shapes with vertex lines parallel to the display surface.

36. The liquid crystal display device of claim 23, wherein the first optical microelements comprise projecting parts having triangular prism shapes projecting oppositely away from the liquid crystal display panel, with vertex lines extending parallel to the display surface.

37. The liquid crystal display device of claim 23, wherein the angular range of the directional distribution is a range from +60 degrees to +90 degrees and from −60 degrees to −90 degrees with respect to the direction normal to the display surface.

38. The liquid crystal display device of claim 22, wherein by controlling the first light source and the second light source, the first light source driving and control unit and the second light source driving and control unit maintain a constant brightness in the direction normal to the display surface.

39. The liquid crystal display device of claim 26, wherein the light having the fourth directional distribution enters into the second optical sheet through the sloping surfaces of the first optical microelements.

40. The liquid crystal display device of claim 29, wherein the first optical member includes:
a light guide plate for converting light output from the first light source to light having a fourth directional distribution in which light having a predetermined or greater intensity is localized to a fourth angular range centered on a direction inclined at a predetermined angle from a direction normal to the display surface, and radiating the converted light toward the liquid crystal display panel; and
a second optical sheet for converting the light having the fourth directional distribution radiated from the light guide plate toward the liquid crystal display panel to the light having the first directional distribution, and for converting the light having the second directional distribution radiated from the second optical member toward the liquid crystal display panel to the light having the third directional distribution, a rear surface of the second optical sheet having a structure in which a plurality of first optical microelements are arranged in a regular array in a plane orthogonal to the direction normal to the display surface, each of the first optical microelements having a sloping surface inclined from the direction normal to the display surface; wherein
the sloping surfaces of the first optical microelements extend in a first extending direction along the rear surface of the second optical sheet; and
the sloping surfaces of the third optical microelements extend in a second extending direction along the rear surface of the first optical sheet, the second extending direction crossing the first extending direction.
